(19) United States
(12) Patent Application Publication
(10) Pub. No.: US 2026/0281144 A1
(43) Pub. Date: Sep. 17, 2026

(54) SYSTEMS AND METHODS FOR ENHANCING CYBERSECURITY

(71) Applicant: Relevant Compliance Inc, Lubbock, TX (US)

(72) Inventors: Nathaniel Thomas Hasse, Lubbock, TX (US); Dylan Levi Ledbetter, Lubbock, TX (US); Jesse Dean Orrico, Bullard, TX (US); Justin Christopher Tabb, Crossville, TN (US)

(21) Appl. No.: 19/543,152

(22) Filed: Feb. 18, 2026

Related U.S. Application Data
(60) Provisional application No. 63/772,261, filed on Mar. 14, 2025.

(51) Int. Cl. H04L 9/40; H04L 41/16

(52) U.S. Cl. CPC H04L 63/1433; H04L 41/16

(57) ABSTRACT

Systems and methods are disclosed configured to receive a first document comprising cybersecurity policies, a second document comprising cybersecurity procedures, and a third document comprising a cybersecurity standard comprising cybersecurity categories. Gaps may be identified between the cybersecurity policies and/or procedures and the cybersecurity standard. Based on the identified gaps, a determination is made as to whether recommendations for cybersecurity remediation techniques are to be generated. In response to determining that cybersecurity remediation techniques are to be recommended, cybersecurity remediation technique recommendations are generated and the cybersecurity remediation techniques may be implemented.

### BACKGROUND OF THE INVENTION

### Incorporation by Reference to any Priority Applications

Any and all applications for which a foreign or domestic priority claim is identified in the Application Data Sheet as filed with the present application are hereby incorporated by reference under 37 CFR 1.57.

### COPYRIGHT NOTICE

A portion of the disclosure of this patent document contains material which is subject to copyright protection. The copyright owner has no objection to the facsimile reproduction by anyone of the patent document and/or the patent disclosure as it appears in the United States Patent and Trademark Office patent file and/or records, but otherwise reserves all copyrights whatsoever.

### BACKGROUND

### Field of the Invention

The present disclosure relates to enhancing the cybersecurity of computer-based information systems.

### Description of the Related Art

As the processing, communication, and storage of data has become essential to modern day life, attempts at improperly obtaining and misusing such data have increased dramatically.

Thus, cybersecurity has become ever more critical to protect individual, business, and governmental sensitive data, prevent cyberattacks, maintain system integrity, and to safeguard critical organizational assets from malicious actors, ensuring operational continuity and preventing losses by protecting against data breaches and identity theft, while also maintaining user trust and complying with data security regulations.

However, with the increase in complexity of networked computer systems, and the increased volume and sophistication of cyberattacks, it has become increasingly difficult to adequately implement best practices to achieve adequate security, particularly for smaller entities that lack sufficient information technology expertise.

### BRIEF DESCRIPTION OF THE DRAWINGS

While each of the drawing figures illustrates a particular aspect for purposes of illustrating a clear example, other embodiments may omit, add to, reorder, and/or modify any of the elements shown in the drawing figures. For purposes of illustrating clear examples, one or more figures may be described with reference to one or more other figures, but using the particular arrangement illustrated in the one or more other figures is not required in other embodiments.

FIG. 1 illustrates an example networked environment.

FIG. 2 illustrates an example architecture.

FIG. 3A illustrates an example neural network architecture.

FIG. 3B illustrates an example transformer architecture.

FIGS. 4-7 illustrate example processes.

FIGS. 8A-8F illustrates example user interfaces.

FIG. 9 illustrates an example multistage validation process.

### DETAILED DESCRIPTION

Modern governments, economies and societies are extremely reliant on computer information systems and computer networks. Indeed, most governments and businesses today cannot operate without the use of such computer resources.

However, computer systems and networks are notoriously vulnerable to cyberattacks intended to improperly obtain data, to misuse computer assets, and/or to degrade the operation of computer systems. The vast panoply of cyberattacks include malware, phishing, SQL injection, denial-of-service (DoS) attacks, Man-in-the-Middle (MITM) attacks, social engineering, cross-site scripting (XSS) attacks, ransomware, password attacks, cryptojacking, DNS tunneling, botnets, and zero-day exploits

In order to protect against such cyberattacks, companies have put policies and procedures in place. However, given the complexity of adequately protecting against such cyberattacks, such policies and procedures are often deficient, particularly when measured against government or industry cybersecurity standards or guidelines intended to better ensure cybersecurity.

Therefore, it would be advantageous to identify (“find”) such deficiencies in cybersecurity policies and procedures with respect to government or industry cybersecurity standards or guidelines, and to generate and implement recommendations to improve such cybersecurity policies and procedures (e.g., for Cybersecurity Maturity Model Certification). Thus, techniques are described herein to enhance cybersecurity, identify deficiencies in cybersecurity policies and procedures, and to generate recommendations to improve such cybersecurity policies and procedures. Such recommendations may then be implemented to improve cybersecurity, protect computer resources, and protect data.

The generation of such recommendations is not adequately possible using manual or conventional computer techniques. There may be myrillions (10\hat{ }{30,003}) of decisions to be made in generating such recommendations which are far beyond the capabilities of humans or conventional computer techniques to process.

It is understood that the techniques, systems, and processes described herein may be utilized to analyze deficiencies in policies and procedures with respect to standards and guidelines other than cybersecurity, and to accordingly generate recommendations to ensure that the policies and procedures better comply with relevant standards and guidelines. For example, the disclosed techniques, systems, and processes may be utilized in terms of analyzing and generating enhancement recommendations (e.g., a plan of action and milestones (POA&M)) for policies and procedures related to determining someone's credit worthiness, healthcare compliance, insurance compliance, and/or the like.

As similarly discussed elsewhere herein, large language models (LLMs) and other generative models may be utilized in analyzing standards, policies and procedures, in generating survey questions to be used in identifying compliance with standards/guidelines, identifying deficiencies in multiple categories with respect to such compliance, and/or in generating recommendations (e.g., a POA&M) with respect to improving such policies and procedures to better achieve certain desired and/or specified goals, such as the improvement of cybersecurity and compliance with cybersecurity standards. Examples of large language models include GPT-4, PaLM, and LaMDA. Although certain examples may refer to an LLM, the disclosed processes and systems may similarly be utilized with respect to other generative models, such as Autoregressive Models, Bayesian Networks, Generative Adversarial Networks, Gaussian Mixture Models, Hidden Markov Models, Latent Dirichlet Allocation (LDA) models, and/or Variational Autoencoders (VAEs).

The POA&M may comprise a corrective action plan (e.g., document or tool) for tracking and planning the resolution of deficiencies in the current policies and procedures. The POA&M may detail the resources (e.g., personnel, technology, funding) needed to accomplish the elements of the plan, milestones for correcting the detected deficiencies, and scheduled completion dates for the milestones. For example, with respect to cybersecurity a corrective action plan may correct deficiencies noted during the assessment of security and privacy controls to reduce the risk to an acceptable level or eliminate known vulnerabilities in the information system.

Thus, with respect to cybersecurity, first a finding may be performed, comprising an assessment and the generation of audit results produced by applying an assessment and audit procedure to, by way of example, a security control, privacy control, and/or control enhancement to achieve an assessment objective. The execution of a determination statement within an assessment procedure may be performed that results in either a satisfied or other than satisfied condition. The findings may identify weaknesses in an information system, system security procedures, internal controls, and/or implementation that could be exploited or triggered by a threat source. Remediation tasks may be generated to address the identified weaknesses.

Remediation milestones may be specific, so as to target a specific area for improvement, measurable so as to quantify or suggest an indicator of progress, assignable so as to specify the resources used to achieve the milestone, and time-related so as to specify when the milestone can be achieved.

As similarly discussed elsewhere herein, an LLM may be utilized in conjunction with a RAG (Retrieval-Augmented Generation) model, in performing processes described herein. A large language model is a type of machine learning model that uses vast amounts of data to learn the statistical patterns of language, such as grammar, syntax, and vocabulary. By way of example, a large learning model may utilize one or more neural networks and may utilize a transformer architecture. The LLM may be trained using unsupervised learning techniques.

Disadvantageously, large language models (LLMs) may not always provide accurate responses to prompts (e.g., queries). LLMs may suffer from such deficits because they are trained using a limited amount of data that may not include data more relevant to the prompt. LLMs may also generate inaccurate, nonsensical or irrelevant responses if the training data is erroneous, unclear or ambiguous.

Disclosed herein are techniques for improving the performance and output of large language and other generative models using improved techniques. Such improved techniques may be utilized to enhance a variety of different types of policies and procedures, and to better ensure their compliance with relevant standards, such as those related to cybersecurity, insurance, contracting, and/or the like.

An LLM may optionally operate within a RAG (Retrieval-Augmented Generation) framework, wherein the policies and procedures serve as an authoritative knowledge base. The RAG framework may be utilized to optimize the output of the large language model, so it references this authoritative knowledge base outside of its training data sources before generating an output.

Documents within the RAG system may be converted into vector embeddings, which are mathematical representations of the documents' content. When a query is received (e.g., responding to a query, analyzing a standard, policy, or procedure), the RAG system may calculate the mathematical similarity (e.g., cosine similarity) between the query embedding and the document embeddings to identify and retrieve the most relevant documents from the knowledge base. Documents with high similarity scores may be considered highly relevant (e.g., accurate and pertinent policies and procedures), while documents with low similarity scores or those falling below a defined threshold may be considered less relevant or potentially misleading. The quality of the RAG system's output may be further improved by curating the knowledge base to include authoritative and accurate documents and to exclude inaccurate or irrelevant documents. Optionally, a user may upload documents to, or remove documents from, the knowledge base to improve the quality and relevance of the RAG system's retrieval results.

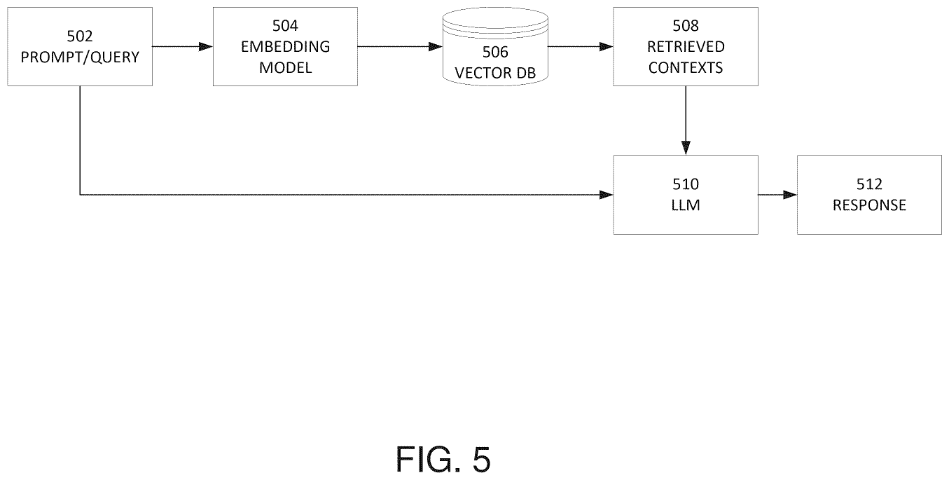

Advantageously, RAG extends the capabilities of an LLM (Large Language Model) to specific domains or an organization's internal knowledge base, without requiring the retraining of the LLM. The use of RAG may ensure that the LLM is configured to generate relevant and accurate outputs for a given application. Hence, RAG advantageously enables the capabilities of an LLM without requiring the same level of computer resources (e.g., processing power, memory, network utilization) that would otherwise be consumed in retraining the LLM. In particular, where RAG is not used, the LLM takes query (or other prompt) input and creates a response based on information the LLM was trained on (i.e., what the LLM already knows). By employing RAG, an information retrieval component is provided that utilizes the query (or other prompt) input to retrieve information from one or more new data sources (e.g., databases, document repositories, APIs, and/or the like). The data may exist in various formats such as files, database records, or long-form text. As will be similarly discussed with respect to FIG. 5, embedding language models may be utilized to convert the data into numerical representations (embeddings), and the numerical representations may be stored in a vector database to generate a knowledge library understandable by the LLM.

For example, a prompt and the relevant new information from the RAG model may be input to the LLM, which in turn utilizes the new knowledge and the LLM's training data to create improved, more accurate responses. For example, a relevancy search may be performed, wherein the prompt is converted to a vector representation and matched with data vectors in one or more vector databases to find relevant data. The RAG model augments the prompt input by adding the relevant retrieved data in context. The augmented prompt allows the LLM to generate an accurate response to the prompt.

Optionally, to maintain current information for retrieval, the documents and embedding representations of the documents may be synchronously or asynchronously updated (e.g., via real-time updates and/or via periodic batch update processing). Thus, the analysis of policies, procedures, implementation of recommendations, and generation of recommendations may be routinely performed thereby ensuring that recommendations are current. By way of illustration, the generated recommendations may be in the form of step-by-step instructions.

Examples of policies that may be leveraged to increase the statistical likelihood that the RAG model returns high-relevance content may comprise one or more of the following, depending on the application for which the RAG model is being utilized:

For CMMC (Cybersecurity Maturity Model Certification) applications:
Incident Response Policy
Risk Management Policy
Configuration Management Policy
System and Communications Protection Policy
Media Protection Policy

For HIPAA applications:
Privacy Policy
Security Policy
Breach Notification Policy.
Access Control Policy
Workforce Sanction Policy

For PCI (Payment Card Industry) applications:
Data Retention and Disposal Policy
Encryption Policy
Vulnerability Management Policy
Incident Response Policy
Acceptable Use Policy

For FTC (Federal Trade Commission) applications:
Data Minimization Policy
Consumer Privacy Notice Policy
Vendor Management Policy
Data Access Policy
Information Security Policy

Examples of high relevance and low relevance compliance procedures that may be utilized to train a RAG model may comprise high relevance and low relevance examples of one or more of the following, depending on the application the RAG model is being utilized for:

For CMMC applications:
Access Credential Revocation Procedure
Security Monitoring and Logging Procedure
Backup and Recovery Testing Procedure
Configuration Change Approval Procedure
Controlled Unclassified Information (CUI) Handling Procedure

For HIPAA applications:
Patient Access to Records Procedure
Employee Training on Privacy Rules.
Audit Log Review Procedure
Incident Reporting and Investigation Procedure
Risk Assessment Procedure

For PCI applications:
Quarterly Vulnerability Scanning Procedure
Change Management Procedure
Secure Payment Processing Procedure
Penetration Testing Procedure
Cardholder Data Backup Procedure

For FTC applications:
Data Breach Response Procedure
Consumer Data Deletion Procedure
Third-Party Vendor Assessment Procedure
Security Incident Reporting Procedure
Data Encryption and Decryption Procedure

Examples of user policies (e.g., that are to be evaluated and scored using the LLM/RAG model) may comprise one or more of the following:

For CMMC (Cybersecurity Maturity Model Certification) applications:
Incident Response Policy
Risk Management Policy
Configuration Management Policy
System and Communications Protection Policy
Media Protection Policy

For HIPAA applications:
Privacy Policy
Security Policy
Breach Notification Policy
Access Control Policy
Workforce Sanction Policy

For PCI (Payment Card Industry) applications:
Data Retention and Disposal Policy
Encryption Policy
Vulnerability Management Policy
Incident Response Policy
Acceptable Use Policy

For FTC (Federal Trade Commission) related applications:
Data Minimization Policy
Consumer Privacy Notice Policy
Vendor Management Policy
Data Access Policy
Information Security Policy

Examples of user procedures (e.g., that are to be evaluated and scored using the LLM/RAG model) may comprise one or more of the following:

For CMMC (Cybersecurity Maturity Model Certification) applications:
Credential Revocation Procedure
Security Monitoring and Logging Procedure
Backup and Recovery Testing Procedure
Configuration Change Approval Procedure
Controlled Unclassified Information (CUI) Handling Procedure

For HIPAA applications:
Patient Access to Records Procedure
Employee Training on Privacy Rules
Audit Log Review Procedure
Incident Reporting and Investigation Procedure
Risk Assessment Procedure

For PCI (Payment Card Industry) applications:
Quarterly Vulnerability Scanning Procedure
Change Management Procedure
Secure Payment Processing Procedure
Penetration Testing Procedure
Cardholder Data Backup Procedure

For FTC (Federal Trade Commission) related applications:
Data Breach Response Procedure
Consumer Data Deletion Procedure
Third-Party Vendor Assessment Procedure
Security Incident Reporting Procedure
Data Encryption and Decryption Procedure

The LLM, optionally in conjunction with a RAG model, may ingest documents, such as standards or guidelines (which may be individually or collectively referred to herein as “standards” for the sake of clarity, unless the context indicates otherwise). In the case of cybersecurity, such standards and guidelines may be established and defined by governmental and/or industry entities. The LLM may analyze a standard by processing its text and identifying key requirements, then generate targeted questions based on these requirements to assess compliance across different aspects of the standard, effectively acting as a compliance “checklist generator” by extracting critical details and formulating specific inquiries to verify adherence to the standard's guidelines across various scenarios.

For example, the LLM, optionally in conjunction with a RAG model, may analyze the text of a standard to identify key concepts, phrases, and relationships between different sections of the standard, extracting elements for generating compliance questions. Based on the extracted information, the LLM, optionally in conjunction with the RAG model, may generate specific natural language queries (e.g., “Is two factor authentication being used?”) that target potential compliance gaps between policies/procedures across different aspects of the standard, considering various scenarios. The RAG model may search (e.g., using a semantic search) the digitized standard and/or other relevant reliable documents, retrieving relevant sections and clauses that directly address the LLM's query.

A risk score may be calculated, using the variables and formulas described below. The risk score may be a weight-based average risk score. A weight based average score may comprise a calculated average where a given data point (e.g., a compliance score for a particular cybersecurity standard's category) is assigned a specific weight or level of importance. Because of such weighting, certain data points contribute more significantly to the final average than other data points, resulting in a more accurate representation of the overall data when certain aspects are considered more important than others.

The formula variable definitions are provided below.

| Term | Definition |
|---|---|
| n | Number of categories |
| mᵢ | Number of questions in category i, where i = 1, 2, . . . , n |
| rᵢⱼ | Typically 4 (Critical) - Maximum risk exposure |
| | level of question j in category i |
| αᵢⱼ | Risk level of the answer to question j in category i |
| sᵢ | Total possible score for category i, typically 100 |
| | points |
| tᵢ | Total risk score for category i |

Risk Score per Category (using a weight based average):

$${\dot{t}}_{i} = {s}_{i} \times ( 1 - \frac{{\sum }_{j}^{{m}_{i}} {a}_{ij}}{{m}_{i} \times {r}_{ij}} )$$

The overall total risk score across all categories may be calculated as the sum of the risk scores for each category:

$$T = {\sum }_{i}^{n} {t}_{i}$$

Where the overall compliance score or a given compliance score for a category fails to satisfy a corresponding threshold, recommendations may be generated to increase the compliance score.

For example, with respect to cybersecurity, the recommendations may include requiring that more secure passwords be used (e.g., longer passwords with a greater mix of alphabetic, numeric, and/or special characters), that multi-factor authentication be used, that software be updated on a scheduled basis, that hardware be updated on a scheduled basis, that a continuous or periodic data backup process be implemented, that data encryption be utilized, that a firewall be implemented to enhance network security, that VPN is utilized to privatize network connections, that anti-virus and anti-malware software products be installed, that adware be removed from systems, that endpoint protection be implemented, that intrusion detection/prevention systems be utilized, that an anti-phishing training program be implemented, that a cyberattack recovery procedure be implemented, and/or the like.

For example, the base score for a given category may be set to 100, there may be four main categories with a total of nine subcategories, where a given subcategory accounts for a total of 10% of the risk score. Of course, a different base score may be used, and there may be different numbers of categories and subcategories.

Certain aspects will now be described with reference to the figures.

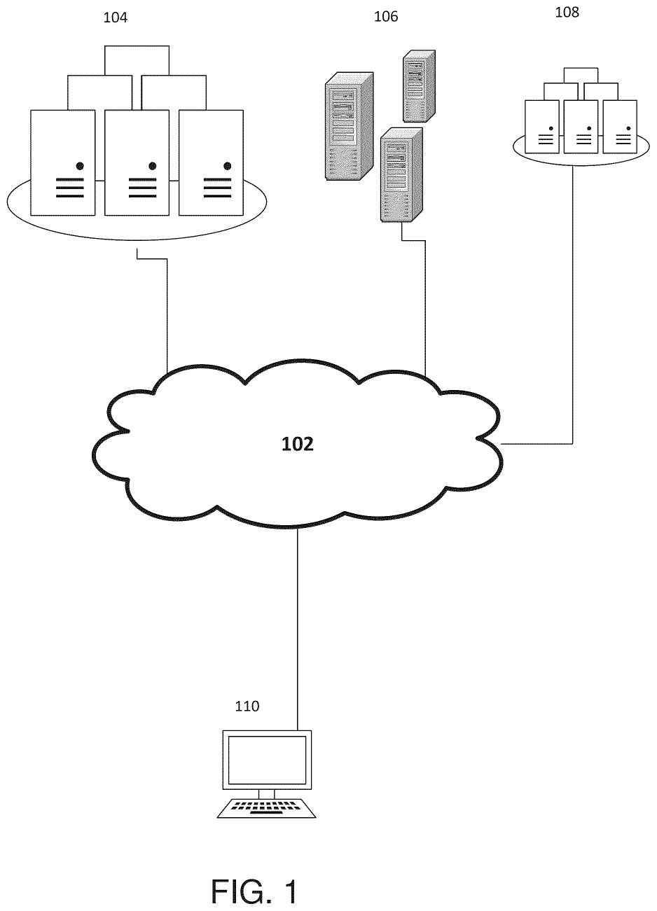

FIG. 1 illustrates an example environment which may be utilized with the processes and systems described herein.

An LLM system 104 is configured to host and execute one or more LLMs.

The LLM system 104 may comprise a cloud system. With respect to the cloud-based computer system implementation, the cloud-based computer system may comprise a hosted computing environment that includes a collection of physical computing resources that may be remotely accessible, located at different facilities, and may be rapidly provisioned as needed (sometimes referred to as a “cloud” computing environment). Certain data described herein may optionally be stored using a data store that may comprise a hosted storage environment that includes a collection of physical data storage devices that may be remotely accessible and may be rapidly provisioned as needed (sometimes referred to as “cloud” storage). Optionally, some or all of the LLM system 104 functionality may be incorporated into the user device 110.

The LLM system 104 may ingest text content and optionally image from a large variety of sources (e.g., webserver 106, database 108, or the like) including webpages, specifications, policies, procedures, guidelines, and/or the like. Such data may be used to train the LLM system 104 (e.g., using an unsupervised or supervised learning approach). The LLM system 104 may access such content from corresponding systems over a network 102 (e.g., the Internet, an intranet, a wide area network, etc.). For example, the LLM system 104 may provide a user or computer interface to one or more content source systems via which content for training may be uploaded or via which a link to content for training may be provided. Such training content may be stored by the LLM system 104 to be used in training.

Optionally, the LLM system 104 may utilize natural language processing (NLP) to extract keywords, and/or perform semantic parsing to extract the structure of the input text.

As similarly discussed elsewhere herein, the LLM system 104 may optionally be utilized as a layer between policies and procedures within a RAG (Retrieval-Augmented Generation) model that serves as the source of truth for policies and procedures (e.g., that may be uploaded by users) for compliance with respect to certifications, standards, specifications, and/or the like.

The LLM system 104 may communicate with one or more end user devices 110 (e.g., a computing device, such as a smartphone, a desktop computer, a laptop computer, a tablet, a smart television, a game console, a smart watch or other wearable, and/or the like) over the network 102. For example, a user may, via one or more user interfaces, upload policies and procedures to the LLM system 104, view and respond to assessment queries provided by the LLM system 104, view LLM generated assessments and assessment scores, view recommendations (e.g., natural language, step-by-step recommendations) generated by the LLM, and/or provide user queries to the LLM system 104 and view responses to user queries from the LLM system 104.

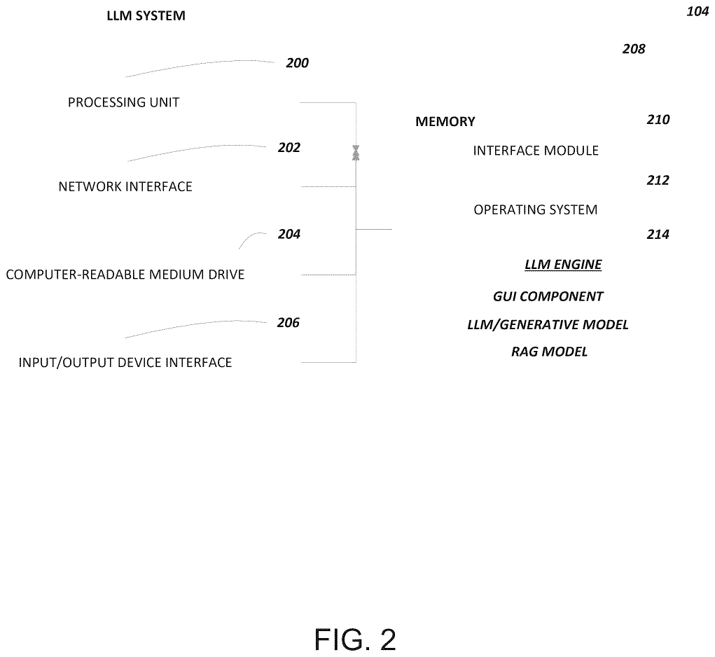

FIG. 2 is a block diagram illustrating example components of the LLM system 104. The example LLM system 104 includes an arrangement of computer hardware and software components that may be used to implement aspects of the present disclosure. Those skilled in the art will appreciate that the example components may include more (or fewer) components than those depicted in FIG. 2. Optionally, computer hardware and/or software components illustrated in FIG. 2 may be instead or also be included in other systems depicted in FIG. 1.

The LLM system 104 may include one or more processing units 200 (e.g., one or more general purpose processors and/or high speed graphics processors comprising one or more processor cores including arithmetic logic units, FFT processors, AI processors, registers, input/output buses, and/or the like), one or more network interfaces 202, a non-transitory computer-readable medium drive 204, and an input/output device interface 206, all of which may communicate with one another by way of one or more communication buses. The network interface 202 may provide services described herein with connectivity to one or more networks or computing systems (e.g., LLM systems, webservers, user devices, remote data sources, etc.). The processing unit 200 may thus receive models and/or information (e.g., LLM models, RAG models, webpages, other content used to train the LLM models and RAG models, high relevance and low relevance training examples, standards, responses to assessment questions, etc.), and/or instructions from other computing devices, systems, or services via a network, and may provide responsive data and/or execute instructions. The processing unit 200 may also communicate data to and from memory 204 and further provide output information via the input/output device interface 206. The input/output device interface 206 may also accept input from one or more input devices, such as a keyboard, mouse, digital pen, touch screen, microphone, camera, etc.

Optionally, the processing unit 200 may include one or more chips (which may optionally comprise one or more field programmable arrays (FPGAs) and/or one or more chiplets/dies, optionally in the same package) optimized for executing and training generative artificial intelligence (AI) models (e.g., LLM models). For example, the processing unit 200 may include a plurality of processing cores configured to work together in parallel to perform multiple calculations simultaneously. The cores may be arranged in one or more arrays to reduce communication delays between cores. The processing unit 200 may comprise dedicated circuitry and instruction sets for performing matrix and tensor operations at high speed. The processing unit 200 may comprise high speed memory buses and local high speed memory to better support generative AI model performance. The processing unit 200 may include vertically stacked integrated circuits to increase computational density and efficiency.

The memory 208 may contain computer program instructions that the processing unit 200 may execute to implement one or more aspects of the present disclosure. The memory 208 may include RAM, ROM (and variants thereof, such as EEPROM) and/or other persistent or non-transitory tangible computer-readable storage media. An interface module 210 may provide access to data in the memory 208 and may enable data to be stored in the memory 208. The memory 208 may store an operating system 212 that provides computer program instructions for use by the processing unit 200 in the general administration and operation of an LLM engine 214, including its components.

The memory 208 may store documents, content and data described herein.

Some or all of the data and content discussed herein may optionally be stored in a relational database, an SQL database, a NOSQL database, or other database type. Optionally, the memory 208 may include one or more external third party cloud-based storage systems.

The LLM engine 214 may include a GUI component that generates graphical user interfaces and processes user inputs (e.g., LLM queries/prompts, assessment questionnaires and responses, standards, policies, standards, and/or other inputs described herein), an LLM (e.g., a generative model comprising a neural network, such as an encoder-decoder recurrent neural network, optionally comprising a transfer architecture) configured to generate and/or select content to present to the user, and a RAG model, configured to enhance the responses of the LLM. The LLM and RAG model may be trained using some or all of the data described herein and/or other data.

Optionally, the LLM engine 214 may comprise a transformer architecture that utilizes self-attention, which enables the model to selectively focus on different parts of the input sequence during the encoding process. The transformer architecture may comprise an encoder and a decoder, connected through one or more multi-head attention and feedforward layers.

The encoder is configured to receive an input sequence and process it using multi-head self-attention, where the input sequence is transformed into a set of query, key, and value vectors. The query, key, and value vectors may be used to compute the attention scores between given positions in the sequence, enabling the model to identify the relevant (e.g., most relevant) portions of the input sequence for respective positions.

The decoder is configured to receive the encoder output and generate an output sequence. The decoder may also utilize multi-head attention and may be further configured with an additional attention mechanism that enables the decoder to attend to the encoder output and to generate the output sequence using the relevant information from the input sequence. For example, an attention module may repeat its computations several times in parallel, which may be referred to as respective attention heads. Optionally, the attention module splits Query, Key, and Value parameters N-ways and passes each, independently, through a separate attention head.

The transformer architecture may comprise one or more feedforward layers, which apply a linear transformation followed by a non-linear activation function to the output of the attention layers. The feedforward layers facilitate further capture patterns in the input and output sequences.

The transformer may comprise a loss function that measures the difference between the predicted output sequence and the true output sequence. The transformer may be configured to minimize or reduce the loss function output. Backpropagation may be utilized as part of the minimization process, where the gradients of the loss function with respect to the model parameters are calculated and used to update the model weights (e.g., associated with neural network layers).

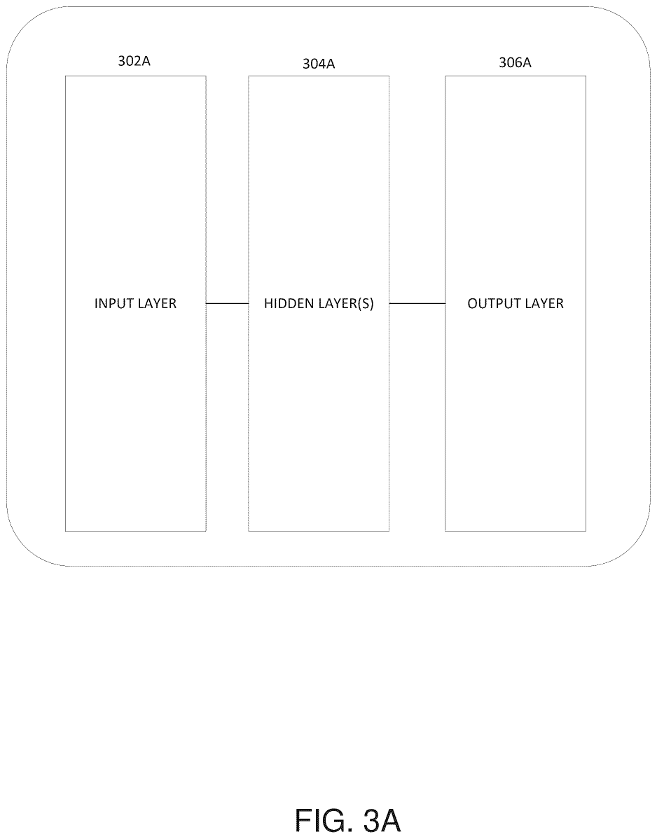

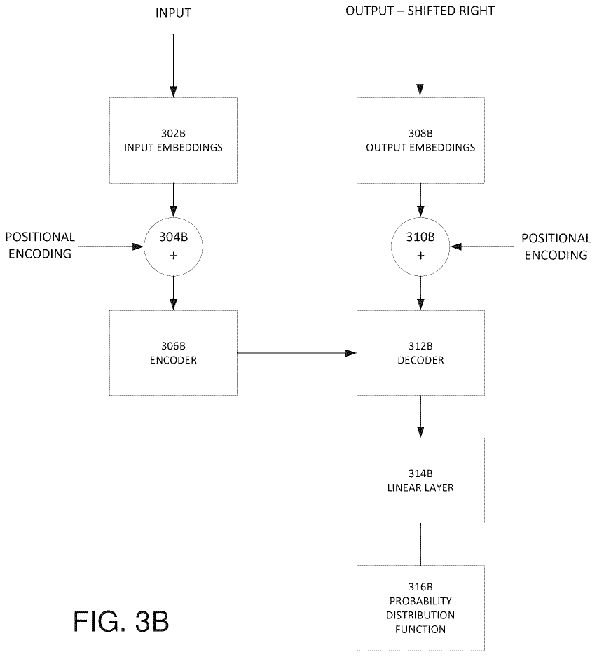

An example of a neural network configured to generate responses to user queries/prompts, such as that described herein, is illustrated in FIG. 3A. Optionally, the neural network may be executing using processors optimized for executing neural networks and generative models, such as described herein. The neural network may also be utilized to analyze a generative model output to determine the source and/or contribution that items of training content made to the training and/or output of the generative model. The neural network may be utilized in a transformer model, such as that described herein.

The neural network may contain an input layer 302A, one or more hidden layers 304A, and an output layer 306A. The hidden layers 304A may be configured as convolutional layers, pooling layers, fully connected layers and/or normalization layers. For example, the neural network may be configured with one or more pooling layers that combine outputs of neuron clusters at one layer into a single neuron in the next layer. Max pooling and/or average pooling may be utilized. Max pooling may utilize the maximum value from each of a cluster of neurons at the prior layer. Average pooling may utilize the average value from each of a cluster of neurons at the prior layer.

The training data (e.g., text, image, or audio) may comprise data scraped from one or more websites, accessed from one or more databases, provided by users, or may be obtained from other sources. For example, the training data may be submitted, via a user or computer interface.

The neural network may be trained using a supervised or unsupervised process. The neural network layer node weights may be adjusted using backpropagation based on an error function output with respect to the accuracy/relevance of the content generated and/or selected by the neural network, to thereby lower the error. The changes of weights may be recorded in memory as the neural network is being trained by respective items of training content. Such recorded changes in weights may be used to generate feedback as similarly discussed elsewhere herein.

A transformer model may be utilized to generate and/or select content for a user (e.g., a standards compliance questionnaire, remediation recommendations in order to improve compliance of policies and procedures with a standard, etc.) as part of a generative model (e.g., an LLM or other generative model). In addition, a transformer model may be utilized to analyze the output of another generative model, such as an LLM. Referring now to FIG. 3B, an example transformer model architecture is illustrated.

Block 302B is configured to receive tokens (a sequence of characters or subwords that represent a single unit of meaning within the input text) and generate input embeddings, where the input text is converted into a numerical format, sometimes referred to as input embeddings. The input embeddings represent words as numbers so as to be suitable for machine learning model processing. During training, the model learns how to create such embeddings so that similar vectors represent words with similar meanings.

Positional encoding may be utilized to encode the position of a given word in the input sequence as a set of numbers. The set of numbers may be input to transformer model 304B, in association with the input embeddings, to enable the model to understand the order of words in a sentence and generate grammatically correct and semantically meaningful output.

A neural network encoder 306B processes the received text and generates a series of hidden states that encapsulate the text context and the text meaning and that represent the input text at different levels of abstraction. Optionally, there may be a plurality of encoder layers. Optionally, the encoder tokenizes the input text into a sequence of tokens (e.g., words or sub-words), and applies one or more serial attention layers, such as individual words or sub-words. Advantageously, such attention layers enable the transformed model to selectively focus on different parts of the input sequence rather than having to treat each word or sub-word the same way, and further advantageously, enables relationships between inputs significantly distanced apart in the sequence to be determined. Such determined relationships facilitate language processing tasks.

The decoder 312B may be trained to predict a next word in a text sequence based on the prior words. This is optionally performed in part by shifting the output sequence to the right so that the decoder is only using the earlier words.

The output is converted to a numerical format, which may be referred to as output embeddings 308B. Positional encoding is optionally performed to facilitate the transformer model understanding of the order of words in a segment (e.g., a sentence). The set of numbers may be input 310B. A loss function, configured to calculate the difference between the transformer model's predictions and the actual values, may be utilized to adjust the transformer model to improve accuracy by reducing the difference between predictions and targets, and hence the error. During training (e.g., using high relevance and low relevance examples of policies and procedures), the output embeddings may compute the loss function and update the transformer model parameters to improve the transformer model performance. During an inference process, the output embeddings may generate output text by mapping the model's predicted probabilities of a given token to the corresponding token in the vocabulary.

The decoder 312B may receive the positionally encoded input representation and the positionally encoded output embeddings and, based on the foregoing, generates an output sequence. There may be one or more layers of decoders 312B. During the training process, the decoder learns how to predict the next word by examining the prior words. The decoder 312B may generate natural language text based on the input sequence and the context learned by the encoder.

A linear layer 314B may map the output embeddings from the decoder 312B to a higher-dimensional space to thereby transform the output embeddings from the decoder 312B into the original input space. A probability distribution function, 316B, such as the softmax function, may be applied to the output of the model's final layer, producing a vector of scores representing the likelihood of each possible output token in the vocabulary given the input sequence. The function may map these scores to a probability distribution over the vocabulary, with higher scores corresponding to higher probabilities.

By converting the output of the model into a probability distribution, the probability distribution function enables the transformer model to produce a prediction for the next token that is both informed by the input sequence and consistent with the language's syntax and semantics. This allows the model to generate fluent, coherent text that reflects the structure and style of the input text.

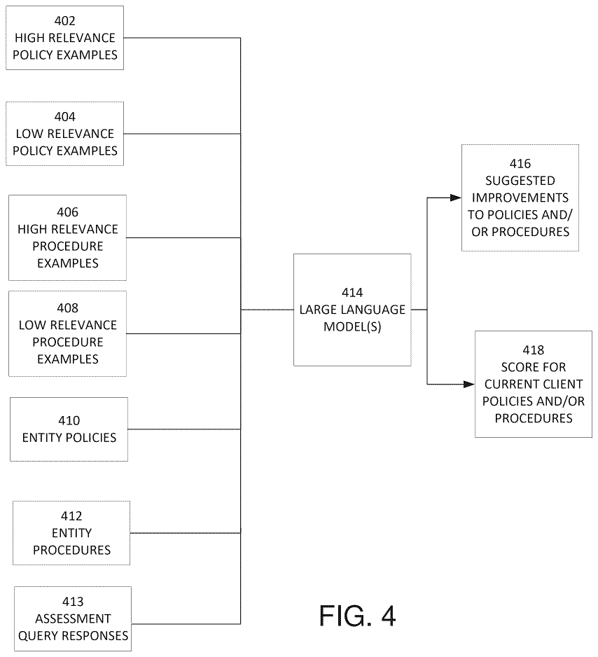

Referring now to FIG. 4, an example process and architecture is illustrated that may be utilized to generate compliance questionnaires, evaluate compliance of policies and procedures with standards, generate category and overall compliance scores, and generate step-by-step recommendations on how to improve compliance of the policies and procedures with the standards.

One or more large language models (LLMs) 414 ingests high relevance policy examples 402, low high relevance policy examples 404, high relevance procedure examples 406, and high relevance procedure examples 408 for training. As similarly discussed elsewhere herein, such examples may be for cybersecurity applications, HIPAA applications, PCI applications, FTC applications, contractor applications, insurance applications, or the like. Optionally, as discussed elsewhere herein, and as illustrated in FIG. 5, the LLM 414 may be utilized in conjunction with a RAG model. The LLM 414 may then ingest an entity's (e.g., a business, government, and/or the like) policies 410 and procedures 412. Optionally, responses by the entity 413 to a compliance assessment questionnaire may be ingested by the LLM 414. The LLM 414 (optionally in conjunction with the RAG model) may generate suggested improvements 416 to the client policies 410 and procedures 412 (e.g., to enhance their compliance with a target standard), which it may output as a file, via a user interface, and/or otherwise. In addition, the LLM 414 may generate compliance scores 418 for a plurality of categories and an aggregate overall compliance score (e.g., using the formulas described herein) which it may output as a file, via a user interface, and/or otherwise.

FIG. 5 illustrates an example process of generating a response to a prompt by an LLM augmented by a RAG model (e.g., to generate compliance questionnaires, compliance recommendations, and other content described herein).

At block 502, a prompt/query (which may be in the form of text) is provided to an embedding model 504 to semantically represent the prompt/query as an embedded query vector. For example, the prompt may be to identify deficiencies of a specified policy and procedure with respect to compliance with a specified standard, and to generate step-by-step recommendations on how to improve the policy and procedure in one or more categories so as to better comply with the standard.

At block 506, the embedded query vector is provided to a vector database. At block 508, a certain number of the relevant contexts are identified. Such top relevant contexts may be selected based on the measured distance between the query embedding and some or all of the embedded chunks in a knowledge base, wherein the smaller the distance the higher the context ranking. At block 510, the prompt/query and the text of the top number of retrieved relevant contexts are provided to an LLM. At block 512, the LLM will generate a response to the prompt/query based on its training and using the provided context.

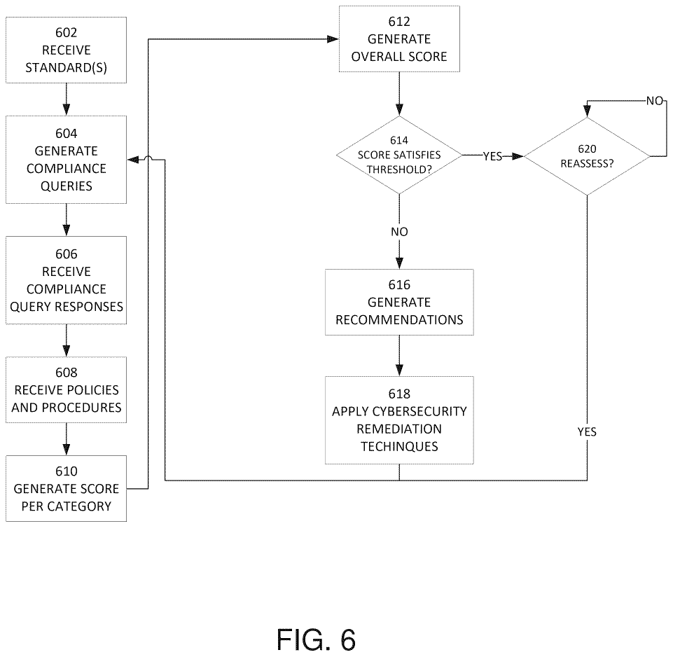

FIG. 6 illustrates an example process of enhancing policies and/or procedures, such as those related to cybersecurity. At block 602, one or more relevant standards are received. At block 604, an LLM, optionally in conjunction with a RAG model, generates text compliance queries. Advantageously, these queries are optionally configured to require only simple responses (e.g., yes or no responses, numerical responses, or the like). Such compliance queries may be provided to a user via a user interface rendered on a user device and/or may be provided via file. At block 606, responses to the compliance queries are received from the user and are stored in memory. At block 608, an entity's policies and procedures are received, where such policies and procedures are configured to attempt to comply with a target standard (e.g., cybersecurity standards, HIPAA standards, PCI standards, FTC standards, contractor standards, insurance standards, or the like).

At 610, compliance scores are generated for a plurality of categories, reflecting how close a given set of policies and procedures comply with respective categories in the standard. Such score may be generated using the formula described herein. Such score may optionally be expressed as a percentage compliance score, wherein 100% means complete compliance, and 0% means no compliance with the respective category. At block 612, an overall compliance score may be generated, optionally using the formula described herein. At block 614, a determination may be made whether the overall compliance score and/or category scores satisfy respective thresholds (e.g., where the threshold may be 80%, 90%, 95%, 100%, or other threshold). Optionally, the compliance scores may be provided via an electronic document or communication to one or more recipients.

If the overall compliance score and/or category scores satisfy respective thresholds, at block 620, a determination may be made as to whether a compliance reassessment is to be performed. For example, a reassessment may be scheduled to be periodically performed (e.g., once a week, once a month, once a quarter, once a year, etc.), in response to a new or updated standard being detected, in response to new information technology equipment being installed, in response to being retained by a new client, and/or for other reasons. If it is determined that a compliance reassessment is to be performed, the process can proceed back to block 604.

If the overall compliance score and/or category scores fail to satisfy respective thresholds, at block 616, remediation recommendations may be generated. Such remediation recommendations may optionally include specific recommendations for each category where the compliance score failed to satisfy the respective threshold and/or may include recommendations when the overall compliance score fails to satisfy the corresponding threshold.

Optionally, an assessment report may be generated, including category compliance scores for respective categories, an overall compliance score, and the remediation recommendations. Optionally, a given category compliance score and remediation recommendation may be presented in conjunction with the corresponding text from the standard (the literal text and/or a summary/paraphrase of the text), and optionally in conjunction with the corresponding text from the corresponding policy and/or procedure, such as in a table format. If the current assessment is a reassessment of the compliance of the policies and procedures, the previous overall and category scores may be accessed from memory and presented in the assessment report in conjunction with the new scores to indicate whether the scores have improved or gotten worse. Optionally, a percentage change in the scores may be calculated and presented. Optionally, graphs of the score(s) may be generated, showing whether the compliance score trend is improving or decreasing over a series of compliance assessments. This enables a user to determine the effectiveness of past remediation techniques and to identify whether any changes to the policies and procedures and/or changes in the requirements have resulted in a negative impact on one or more category compliance scores and/or the overall compliance score. The assessment may optionally include an automatically generated plan of action and milestones (POA&M), that clearly identifies what remediation tasks are to be performed, when they are to be performed, and optionally who (what person, job function and/or department) is to perform the tasks.

An example of scoring and updating scoring after remediation is as follows:

Assuming there are three sections (Sections, 1, 2, 3) to the assessment survey, and the base score is 100:
Section 1—Risk Assessment—300 Possible Points
Section 2—Access Controls—300 Possible Points
Section 3—Information Security Program—300 possible points
Total Possible Score=1,000

### Initial Survey

Section 1—1 Urgent, 1 High and 1 Medium Vulnerability out of 3 questions=Score 0
Section 2—Zero Vulnerabilities—Score 300
Section 3—1 Urgent Vulnerability (out of one question taken)—Score 0
Initial Score—400/1000

### Post-Task Creation and Remediation

Section 1—1 Medium vulnerability remains (with a criticality level of 1)—the High and Urgent are resolved=score=249.9
Section 2—Score 300
Section 3—all vulnerabilities remediated—score 300
Post Task Remediation Score=949.9 out of 1,000

At block 618, the recommendations may be implemented. For example, if the standard relates to cybersecurity, the recommendations may relate to enhancing cybersecurity. The process may then proceed back to block 604, and compliance may be reassessed after some or all of the recommendations are implemented.

As similarly discussed elsewhere herein, a compliance reassessment may optionally be scheduled to be automatically periodically performed (e.g., once a week, once a month, once a quarter, once a year, etc.), to optionally be automatically performed in response to a new or updated standard being detected, to optionally be automatically performed in response to new information technology hardware and/or software equipment being installed, in response to one or more new employees being hired, and/or for other reasons.

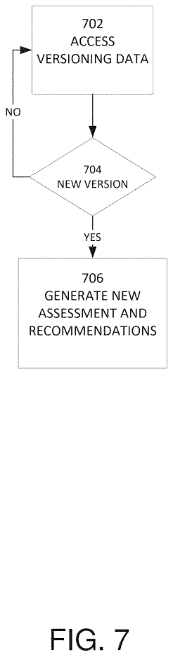

FIG. 7 illustrates an example process, wherein a compliance reassessment may be performed at least partly in response to detecting a change in a relevant standard. Optionally, the process may be similarly performed in response to detecting a change in a policy or procedure. The process may optionally be automatically executed based on a user-defined schedule and/or based on a specified period (e.g., once a week, once every two weeks, once a month, once every six months, once a year, or the like) to determine if the relevant standard has changed, and hence whether a compliance reassessment is to be performed. At block 702, a standard and/or metadata associated with the standard (e.g., a version number, a release date, a change document, and/or the like) may be accessed from a standard source (e.g., a webpage, a database, and/or the like). The standard may optionally be accessed as a webpage, as a Portable Document Format (PDF) document, as a word processing document, and/or otherwise. A determination may be made as to whether the standard has changed since the last time a given entity has conducted a compliance assessment to determine if their policies and/or procedures comply with the standard.

For example, when a compliance assessment is performed with respect to a standard, a version number of the corresponding standard may be stored in association with the compliance assessment. At block 704, the current version number of the standard may be accessed and compared with the standard version number associated with the previous standard's compliance assessment. If the version numbers differ, a determination may be made that the standard has changed. By way of further example, when a standard's compliance assessment is performed, a checksum (a hash) may be generated for the current corresponding standard and the checksum may be stored in association with the compliance assessment. At block 702, the current standard may be accessed and a new checksum may be generated. The new checksum and the previously generated checksum may be compared, and if there is a difference in the checksums, a determination may be made that the standard has changed.

If it is determined that the standard has not changed, the process may continue monitoring the standard to detect when and if a change has occurred. If it is determined that the standard has changed, the assessment, recommendation, and remediation acts described above with respect to FIG. 6 may be performed. At block 706, a new assessment report may be generated, including category compliance scores for respective categories, an overall compliance score, and/or the remediation recommendations. As similarly discussed elsewhere herein, optionally, a given category compliance score and remediation recommendation may be presented in conjunction with the corresponding text from the standard, and optionally in conjunction with the corresponding text from the corresponding policy and/or procedure, such as in a table format. Optionally, the previous category compliance scores may be accessed from memory and presented in the compliance reassessment report in conjunction with the new compliance category scores to indicate whether the scores have increased or decreased. Optionally, a percentage change in the scores may be calculated and presented. Optionally, graphs of the score(s) may be generated, showing whether the compliance score trend is improving or deteriorating. The assessment may optionally include an automatically generated POA&M report that identifies what remediation tasks are to be performed, when they are to be performed, and optionally who (what person, job function, and/or department) is to perform the tasks.

For example, the POA&M report may optionally specify a name of the information system(s) for which the POA&M is generated, the names and dates of the policies, procedures, and standards to which it applies, and the date/time the assessment survey was performed. Optionally, an operator/user name may be included in the POA&M report. Optionally, the generated POA&M report may categorize and prioritize risks (e.g., NIST 800-53, CIS Controls, and/or the like) so that higher risk deficiencies (those associated with a higher criticality designation) may be scheduled to be remediated before lower risk deficiencies. For example, Common Vulnerability Scoring System (CVSS) or custom risk levels may be utilized to assign risk designations. Compliance deficiencies may be mapped to recommended remediations tasks (e.g., using NIST, CIS, or MITRE ATT&CK databases). An automation script may be utilized to generate a structured POA&M report. The foregoing process may advantageously automatically generate updates when new compliance failures and/or changes to the standard are detected.

An example POA&M report is provided below, comprising a title/header section, an overview, identified gaps and risk assessment, action plan and remediation strategy, milestones and timeline, risk mitigation and monitoring, and resources needed.
“Title
Plan of Action and Milestones (POA&M)
System Name: Enterprise Network Security
Date: [MM/DD/YYYY]

### 1. Overview

This POA&M outlines the corrective actions required to address identified cybersecurity deficiencies and improve the security posture of the organization's information technology infrastructure. This POA&M identifies gaps between the selected cybersecurity standard (e.g., NIST 800-53, ISO 27001, CIS Controls) and the company's current cybersecurity policies and procedures. The POA&M provides a plan for remediation, assigns responsibilities, and establishes milestones and timing for achieving compliance.

### 2. Identified Gaps and Risk Assessment

| | Standard Control | Current Policy | Risk | | Date |
|---|---|---|---|---|---|
| ID | Requirement | Deficiency | Level | Source | Identified |
| 001 | Access Control (NIST | Company policies do | High | Policy | Feb. 10, 2025 |
| | AC-2): Organizations | not define RBAC | | review | |
| | must enforce role-based | implementation for | | | |
| | access control (RBAC) | privileged users. | | | |
| 002 | Multi-Factor | MFA is only required | High | Security | 21 Dec. 2025 |
| | Authentication (NIST | for VPN but not for | | assessment | |
| | 1A-2): MFA must be | cloud applications. | | | |
| | implemented for remote | | | | |
| | access. | | | | |
| 003 | Incident Response Plan | No formalized IRP or | Medium | Compliance | Feb. 15, 2025 |
| | (NIST IR-4): | tabletop exercises are | | audit | |
| | Organizations must | conducted. | | | |
| | document and test an | | | | |
| | incident response plan | | | | |
| | (IRP). | | | | |
| 004 | Logging & Monitoring | SIEM is in place but | Medium | Security | Feb. 18, 2025 |
| | (NIST AU-12): | lacks real-time alerting | | assessment | |
| | Centralized logging of | for critical security | | | |
| | security events must be | events. | | | |
| | enabled. | | | | |
| 005 | Data Encryption (ISO | Only data in transit is | High | Internal | Feb. 20, 2025 |
| | 27001 A.10.1.1): | encrypted, but storage | | audit | |
| | Sensitive data must be | encryption is not | | | |
| | encrypted at rest and in | enforced. | | | |
| | transit. | | | | |

### 3. Action Plan & Remediation Strategy

| | | | Estimated | |
|---|---|---|---|---|
| | | | Completion | |
| ID | Corrective Action | Assigned To | Date | Status |
| 001 | Define and enforce RBAC policy for | Security Policy | Mar. 1, 2025 | In |
| | all privileged accounts. | Team | | Progress |
| 002 | Implement MFA for all cloud-based | IT Security | Mar. 15, 2025 | Planned |
| | applications and enforce policy | Team | | |
| | updates. | | | |
| 003 | Develop and test an Incident | Cybersecurity | Mar. 30, 2025 | Not |
| | Response Plan (IRP), conduct | Director | | Started |
| | quarterly tabletop exercises. | | | |
| 004 | Enhance SIEM capabilities to | SOC Team | Apr. 10, 2025 | Planned |
| | generate real-time alerts for security | | | |
| | incidents. | | | |
| 005 | Implement encryption for data at rest | IT Compliance | Apr. 15, 2025 | Not |
| | and update encryption policies | Team | | Started |
| | accordingly. | | | |

### 4. Milestones and Timeline

Phase 1 (By Mar. 1, 2025):
Draft and approve the RBAC policy.
Phase 2 (By Mar. 15, 2025):
Enforce MFA on all cloud applications.
Phase 3 (By Mar. 30, 2025):
Develop an incident response plan and conduct the first tabletop exercise.
Phase 4 (By Apr. 10, 2025):
Configure SIEM (Security information and event management) system for
real-time alerts and validate event monitoring improvements.
Phase 5 (By Apr. 15, 2025):
Enable encryption at rest for sensitive data and enforce security controls.

### 5. Risk Mitigation & Monitoring

Weekly Security Governance Meetings: To track progress on remediation efforts.
Automated Compliance Audits: To verify policy updates and control implementations.
CISO Review & Sign-Off: Final validation before closing remediation actions.

### 6. Resources Needed

IT Security Engineers for RBAC & MFA implementation.
Compliance and Policy Analysts for documentation updates.
Budget for SIEM enhancement and encryption solutions.
Training for employees on new cybersecurity policies.”

Optionally, an electronic notification may be generated and transmitted to one or more destinations (e.g., email addresses, messaging addresses, a dedicated compliance application hosted on one or more user devices, and/or the like). The notification may optionally be transmitted in real time to the destinations. The notification may optionally indicate that the standard has changed, how the standard has changed, what sections of the standards have changed or been added, and/or make include the reassessment reports or a link thereto.

Thus, the above processes provide automated updates and proactive notifications regarding changes in standards and new compliance assessments with respect to such changed standards. Such processes enable the management of compliance assessments and enable compliance with standards to be maintained.

Certain example user interfaces will now be described. The user interfaces may be populated by the systems and processes described herein. The user interfaces may be rendered on under devices.

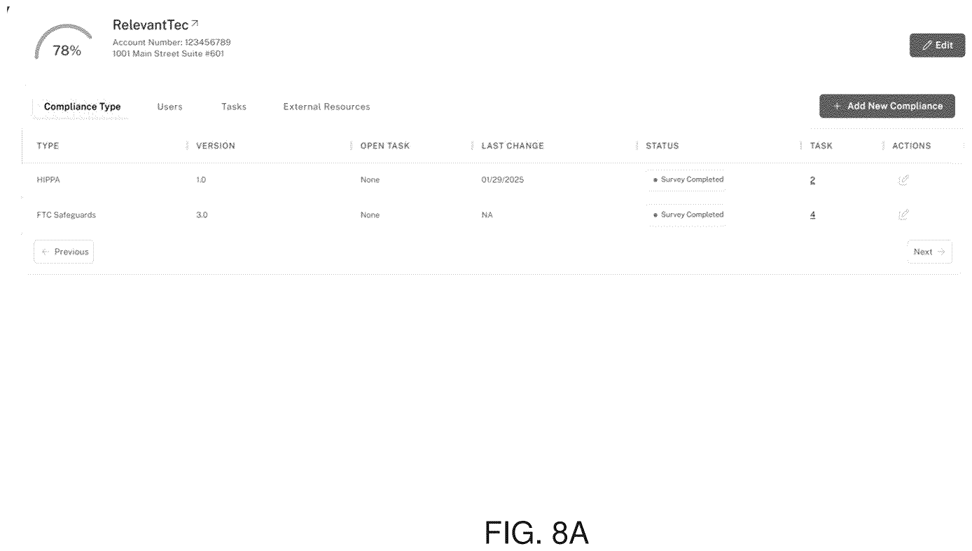

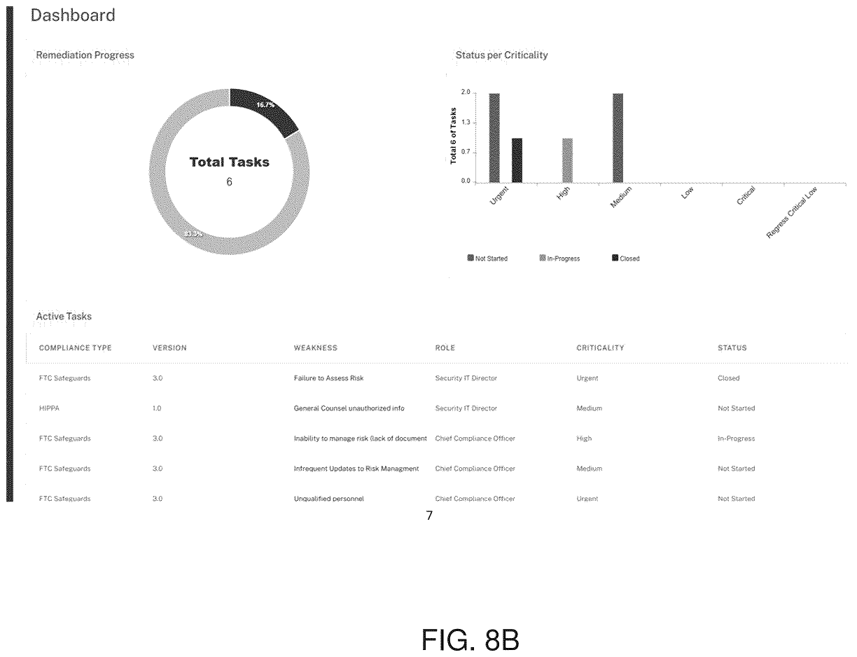

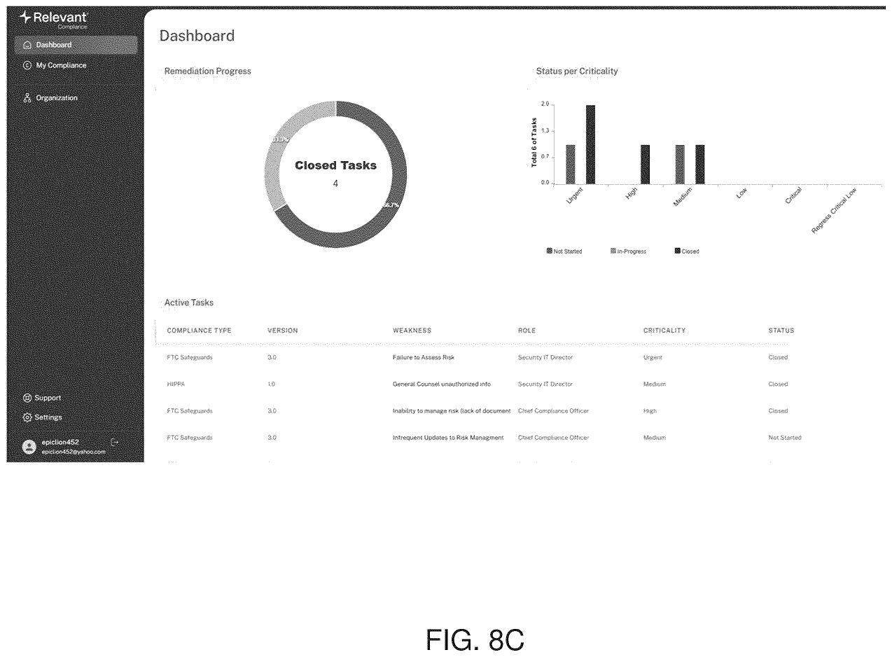

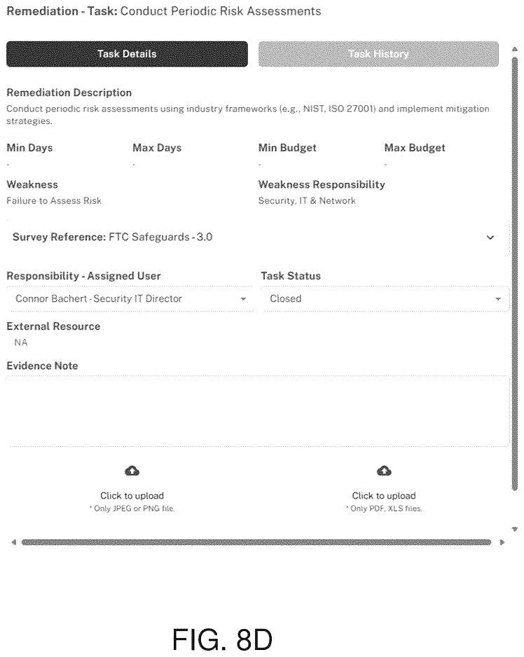

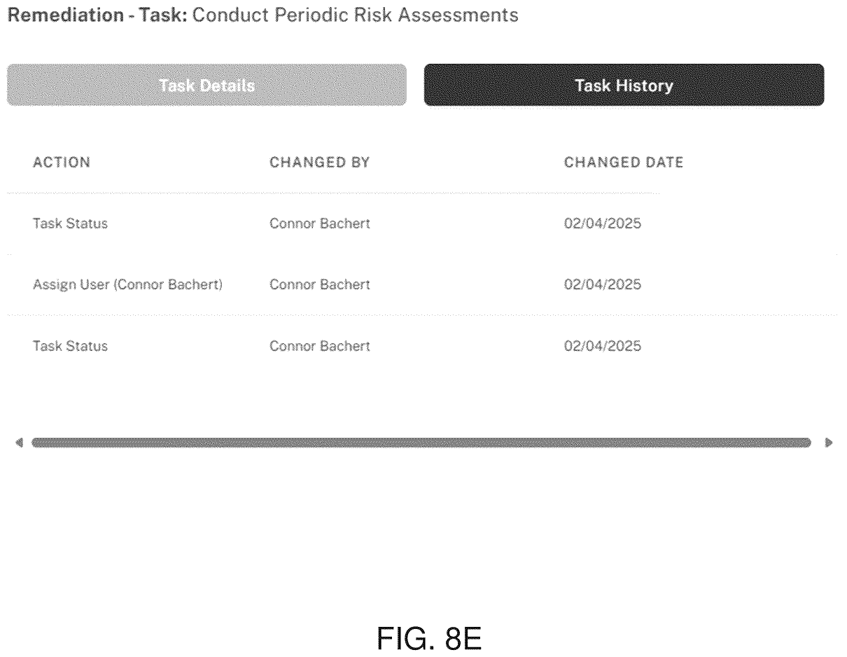

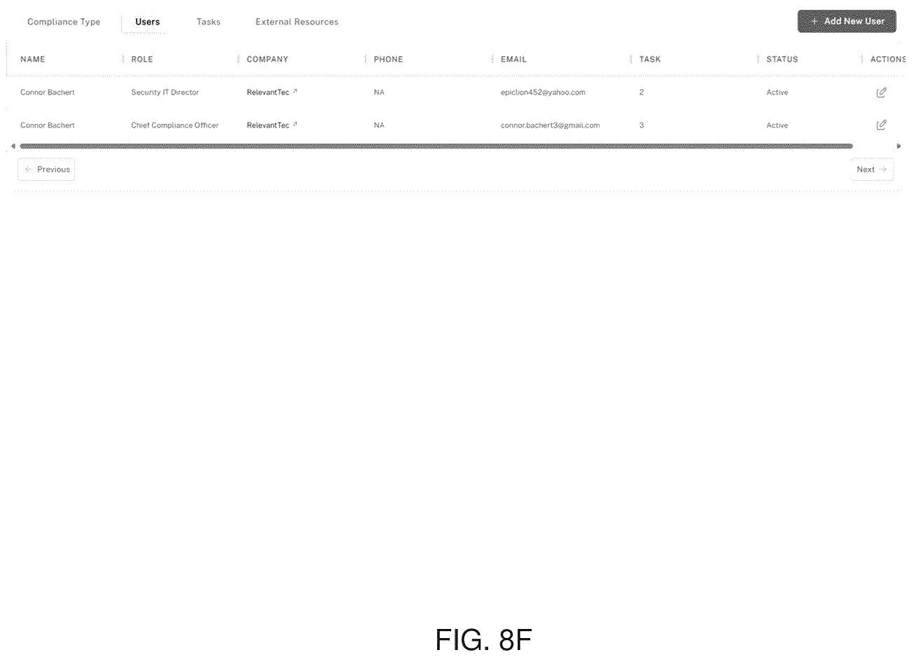

FIG. 8A illustrates an example user interface, providing data after having conducted two surveys/assessments. The user interface provides compliance type indicating the standard/requirements for which the assessment is being performed (e.g., HIPAA, FTC Safeguards, etc.), the version of the standard, what tasks are still open, when was the last change, the survey/assessment status (e.g., completed, in process, etc.), task, and actions.

FIG. 8B illustrates an example remediation tasks dashboard providing information on the tasks that need to be performed to achieve compliance (e.g., 100% compliance) with the relative standard. In this example, a total tasks graph is generated, indicating visually and numerically the number of total tasks (e.g., 6 tasks), the percentage of tasks completed and the percentage of tasks not yet completed. A status-per-criticality bar graph depicts the number and status (e.g., not started, in progress, closed) of tasks of different criticality levels (e.g., urgent, high, medium, low, critical). A table provides details on the active tasks. The example table includes the following columns: compliance type, version, identified weakness, the role of the person to whom the task is assigned, the criticality, and the status.

FIG. 8C illustrates an example remediation tasks dashboard that has been updated once a remediation task is completed. In this example, once remediation is closed the remediation progress is then updated. A total tasks graph is generated, indicating visually and numerically the number of tasks completed (e.g., 4 tasks), the percentage of tasks completed and the percentage of tasks not yet completed. Other portions of the user interface are similar to those in FIG. 8B.

FIG. 8D illustrates an example user interface providing detailed information on a remediation task (e.g., conduct periodic risk assessments) configured to address a weakness of the surveyed process or system. The various fields may be populated via the systems and methods described herein, and/or by a user via corresponding fields and menus.

The user interface provides a textual remediation description, an allocated minimum number of days and maximum number of days allocated to perform the remediation task, and an allocated minimum budget and maximum budget allocated to perform the remediation task. The identified weaknesses are textually described (e.g., failure to assess risk), and the assigned responsibility to remediate the weakness (e.g., security, IT & network) is identified. The user interface may identify the reference document or standard that the survey/assessment is being run against to determine if the assessed policies and procedures comply and a compliance score. Optionally, a user may select the reference document or standard via a dropdown menu. An assigned responsible person who is supposed to perform the remediation task may be identified. Optionally, a user may select the person via a dropdown menu A task status interface may be used to identify the task status. Optionally, a user may select the status via a dropdown menu. An external resource that may be utilized to perform the remediation task may be identified. A control may be provided via which the populated user interface may be uploaded to the system (e.g., as a PDF or PNG file).

FIG. 8E illustrates an example user interface populated with a remediation task history. A table is provided including columns for the action related to the task, a “changed by” column identifying the corresponding person that performed the action resulting in the change, and the change date.

FIG. 8F illustrates an example user interface providing a table identifying tasks assigned per user/user role. The table enables a user to view what remediations tasks are assigned and to what user/user role. The table includes a name column for the names of persons assigned the task, a role column for the roles of the persons assigned the task (e.g., Security IT Director, Chief Compliance Officer, etc.), a company column for the name of the company of the persons assigned the task, a phone column for the phone numbers of the persons assigned the task, an email column for the email address of the persons assigned the task, a task column for the corresponding task identifiers, a status column for the corresponding task statuses, and an actions column with an associated edit control.

Optionally, the system described herein (e.g., system 104) is configured to provide real-time, question-level artificial intelligence (AI) generated guidance during the completion of compliance surveys with respect to standards/guidelines or other sources. Rather than limiting AI feedback to post-survey analysis, the example system is optionally configured to generate guidance on a per-compliance survey question basis in real time (e.g., immediately after the user responds to a given compliance query). To do so, the trained AI engine retrieves relevant contextual materials through a Retrieval-Augmented Generation (RAG) framework, such as that disclosed elsewhere herein, wherein the retrieval corpus may include documentation uploaded by the assessed entity, such as spreadsheets, Portable Document Format (PDF) files, word processing documents, slide presentations, and other structured or unstructured records; applicable compliance rules, regulatory frameworks, and/or standard-setting documents; and/or curated examples of compliant and non-compliant responses, and/or other useful corpus.

Using some or all of the foregoing sources, the system performs a multistage validation process using multiple models to provide recommendations and recommendation verification. For example, a primary AI model (which may be included in LLMs 414 illustrated in FIG. 4) may be used to analyze the retrieved source materials according to a pre-defined ruleset and generate an initial recommendation. A secondary AI model (which may be included in LLMs 414 illustrated in FIG. 4) may then independently evaluate the primary model's output to verify accuracy, internal consistency, interpretive fidelity to the underlying standards, and/or alignment with best practices in compliance assessment.

A predefined ruleset may comprise a structured collection of regulatory criteria, scoring heuristics, interpretive directives, and/or decision-making parameters that govern how the system analyzes retrieved contextual materials and formulates compliance-related guidance. Such a ruleset may encode explicit mappings between regulatory controls, required documentation elements, permitted response classifications, corresponding risk levels, and/or the like, thereby ensuring that recommendations produced by the system adhere to the applicable standards and/or internal methodological constraints.

Using such a ruleset, the primary model may evaluate the content of a given response to a compliance question and determine whether it satisfies, partially satisfies, or fails to satisfy the applicable control requirements. For example, in response to a compliance question regarding authentication safeguards, the system may generate an initial recommendation indicating that multi-factor authentication should be implemented where the retrieved documents or user-provided answers reflect reliance solely on single-factor authentication. Such an initial recommendation may further include a model-generated rationale referencing one or more deficiencies, such as lack of compliance, identified under the ruleset, such as the absence of a second authentication factor required under a given cybersecurity standard.

By way of illustrative example, the system may utilize a large-scale generative artificial intelligence model as the primary model configured to generate compliance guidance, evaluate documentation, and formulate preliminary recommendations. The primary model may optionally comprise a large language model (LLM), such as a transformer-based generative model, configured to perform context-aware reasoning over retrieved reference materials, such as those described herein. An example transformer model architecture is illustrated in FIG. 3B and described elsewhere herein. The model may be trained using a wide variety of content, such as some or all of the content described herein.

By way of illustration, optionally the model may be trained using a broad range of content, including high relevance and low relevance examples of policies and procedures across multiple regulatory domains, such as cybersecurity, HIPAA, PCI, and/or FTC frameworks. This training corpus may include items such as incident response policies, risk management policies, configuration management policies, privacy policies, breach notification policies, vulnerability management policies, data minimization policies, corresponding procedural documents such as credential-revocation procedures, security monitoring and logging procedures, audit-log review procedures, penetration-testing procedures, and consumer-data deletion procedures.

The primary model may also ingest actual client-provided policies and procedures, as well as user responses to compliance assessment questionnaires used to identify gaps relative to standards. Additional training sources may include the full text of applicable standards and guidelines (e.g., CMMC, HIPAA, PCI, FTC Safeguards, NIST 800-53, ISO 27001, CIS Controls, etc.) which the model analyzes to extract requirements and generate compliance queries. The system may further draw on contextual materials retrieved through the RAG component, including spreadsheets, PDFs, word-processing documents, slide decks, internal records, and/or curated examples of compliant and non-compliant responses. Optionally, the model may incorporate content sourced from webpages, databases, and other external sources accessed through networked systems. Optionally, audit logs, AI-generated recommendations, and historical validation data may also serve as part of the broader training ecosystem used to refine and improve model outputs.??

Thus, the primary model is responsible for processing RAG-retrieved contexts, interpreting compliance rulesets, and producing an initial recommended answer, risk classification, and/or supporting rationale.

The secondary model may likewise be a large language model but may be distinct from the primary model in architecture, training data, or reasoning style so as to provide an independent evaluative layer. The secondary model may also comprise a transformer-based generative model configured to review and validate the output of the primary model. As similarly discussed above, the secondary model may evaluate whether the primary model's recommendation is internally consistent, accurate, factually supported by the retrieved materials, and aligned with established best practices in compliance assessment. The secondary model may further detect hallucinations, omissions, logical inconsistencies, and/or misinterpretations of regulatory standards.

Optionally, the secondary model may be configured to perform a multi-dimensional validation of the primary model's recommendation by applying a set of interpretive, logical, and/or evidentiary checks to determine whether the recommendation is internally consistent, factually supported by the retrieved materials or is lacking such support, and aligned with established best practices in compliance assessment. To perform this validation, the secondary model may receive as input the primary model's proposed recommendation, the supporting rationale generated by the primary model, and the contextual materials retrieved during the RAG process. The secondary model may generate independent embeddings for a given input, including embeddings corresponding to the relevant sections of the applicable compliance standard, the user-provided documentation, and any referenced guidelines.

Using these embeddings, the secondary model may compute similarity scores, cross-attention weights, and/or token-level alignment metrics to determine whether the recommendation is adequately grounded in the retrieved materials and whether the cited evidence corresponds semantically and contextually to the asserted rationale.

For example, the transformer architecture utilized by the disclosed large language model (LLM) may optionally employ cross-attention weights to enable the decoder to selectively focus on, and extract relevant information from, the encoded representations of input sequences. As described herein, the transformer model comprises an encoder configured to generate a series of hidden states representing the contextual meaning of the input text, and a decoder configured to receive both the positionally encoded output embeddings and the encoder output in order to generate an output sequence. During this process, cross-attention weights are computed by forming query vectors from the decoder, and key and value vectors from the encoder output, thereby allowing the decoder to attend to specific portions of the encoded input when predicting each next token. The attention module may repeat these computations in parallel across multiple attention heads, with a given head applying its own learned weighting to determine the degree of relevance of each encoded token to the decoder's current prediction step. These cross-attention weights advantageously enable the LLM to incorporate the most pertinent contextual information from retrieved documents, cybersecurity standards, policies, and procedures when generating compliance assessments, remediation recommendations, and other outputs described herein, thereby improving accuracy, reducing hallucination propensity, and ensuring that the model's behavior is grounded in authoritative source material.

Token-level alignment metrics comprises quantitative measures that evaluate how the generative model's behavior aligns with desired outputs at the granularity of individual tokens, rather than at the sequence level. Such metrics assess per-token probabilities, reward signals, divergences, and preference satisfaction by decomposing sequence-level supervision into token-specific objectives, thereby enabling fine-grained control, precise credit assignment, and targeted error detection within autoregressive generation processes. These metrics may include per-token rewards, token-wise KL divergence, token distribution shift analysis, and token-level misalignment estimations derived from mutual-information and/or graph-based token-interaction models. By focusing on the contribution of a given token to the overall output, token-level alignment metrics enhance model performance, improve convergence efficiency, and mitigate the noise inherent in sequence-level optimization, ensuring that alignment methods correctly and more accurately identify and adjust the specific tokens responsible for preferred or non-preferred model behavior.

The secondary model may further execute consistency checks to determine whether the primary model has applied regulatory criteria in a manner that deviates from the ruleset or contradicts other parts of its reasoning.

To detect hallucinations or unsupported assertions, the secondary model may compare a given factual assertion in the primary output against the retrieved corpus, identify assertions with no traceable source match above a defined similarity threshold, flag absent or contradictory evidence, and classify the assertion as potentially hallucinated or speculative. By way of example, to detect omissions, the secondary model may analyze the retrieved materials to identify high-salience regulatory requirements or contextual elements that the primary model failed to address, using salience-weighted ranking, coverage analysis, and requirement-to-response mapping derived from the ruleset.

To detect logical inconsistencies, the secondary model may apply rule-based and/or transformer-based entailment/contradiction classification to determine whether the primary model's reasoning is self-contradicting (the reasoning contradicts itself), conflicts with the retrieved materials, or misinterprets regulatory controls. In response to an identification of a misinterpretation of a regulatory standard (e.g., an incorrect paraphrase of a control requirement or an improperly relaxed compliance threshold), the secondary model may generate structured feedback specifying the nature of the deviation, the correct interpretation of the control, and supporting citations to the underlying standard. The secondary model may output a validation result comprising a confidence score, a list of detected issues (e.g., hallucination, unsupported rationale, incomplete coverage, logical inconsistency), and corresponding corrective guidance. This feedback may be provided to the primary model, a workflow controller, or directly to the user interface to enable correction, regeneration, or final review of the recommendation before it is stored, transmitted, or used for compliance scoring.

Optionally, the primary and secondary models may be configured to have divergent training characteristics, such as differences in model size, objective functions, multimodal capabilities, and/or alignment tuning, thereby increasing the strength of the system's two-stage validation workflow. The independence of the secondary model's review provides an additional assurance layer ensuring that the system's final guidance is both reliable and traceable to authoritative source materials.

The resulting AI guidance (which may comprise text, graphics, still images, video, and/or sound) on how to remediate a non-compliance condition may optionally include a recommended answer mapped directly to the available response options, an indication of the compliance risk level (e.g., compliant, warning, critical, or unknown), a confidence score representing the model's certainty, and/or a set of cited evidentiary excerpts drawn from the underlying documents. The guidance may further include detailed reasoning, including quotations and/or paraphrases from relevant source materials, and one or more actionable remediation recommendations when deficiencies are detected. Once the user selects a recommended answer, some or all of the corresponding AI generated guidance is optionally frozen and stored in a corresponding record ensuring that the guidance, including the recommendation, remains preserved for subsequent review, auditing, and/or analysis alongside the user's final answer to the compliance survey.

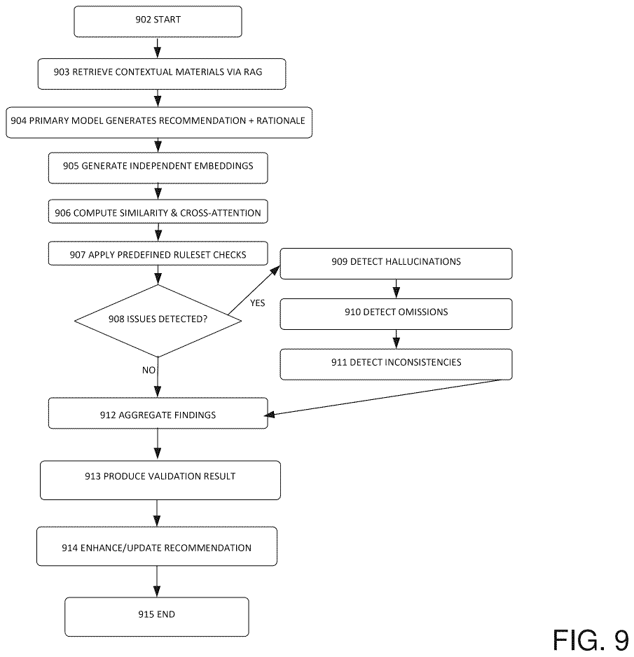

FIG. 9 illustrates an example multistage validation process performed by the system to evaluate and verify a compliance recommendation generated by an AI model. The process begins at block 902, wherein the validation workflow is initiated. At block 903, the system retrieves contextual materials (e.g., policy documents, standards, guidelines, or other relevant data such as that disclosed herein) via a retrieval-augmented generation (RAG) component.

At block 904, a primary AI model generates an initial compliance recommendation and an associated rationale based on the retrieved contextual materials. At block 905, the system generates independent embeddings for the recommendation, the rationale, and portions of the retrieved contextual materials, enabling semantic comparison during downstream validation. At block 906, the system computes similarity scores, cross-attention weighting, and/or other alignment metrics to determine the degree of support for the recommendation and rationale within the retrieved sources. At block 907, the system applies a predefined ruleset to ensure that the interpretation of standards, criteria, and regulatory expectations conforms to authoritative guidance.

A decision is made at block 908 to determine whether any issues are detected in the primary recommendation or rationale. If issues are identified, the process proceeds to a validation branch.

In the validation branch path, at block 909 hallucination detection is performed by identifying assertions in the recommendation or rationale that are unsupported by retrieved contextual materials. At block 910, the system detects omissions by identifying regulatory requirements, control expectations, and/or contextual elements that are missing from or insufficiently addressed in the recommendation. At block 911, the system detects logical inconsistencies, such as contradictions within the recommendation, misinterpretations of standards, and/or inconsistencies between the rationale and the underlying materials.

At block 912, the process converges, and findings from hallucination detection, omission detection, and inconsistency detection are aggregated into a structured validation summary. At block 913, the system produces a structured validation result that includes a confidence score, issue categories, corrective guidance, and/or citations to supporting materials identified during the validation process. At block 914, the system uses the validation result to enhance or update the original compliance recommendation, ensuring that it is accurate, fully supported, and aligned with regulatory requirements. At block 915, the process ends.

Optionally, the example system comprises an administrative portal configured to provide configuration, authoring, and/or deployment capabilities for creating and managing compliance surveys. The administrative interface may be implemented as a web-based or native application backed by an application server and/or a relational or document-oriented database. The portal is optionally further configured to enable the construction of complex recursive question structures, wherein a given question node may include one or more nested sub-questions. These sub-questions may be organized into a hierarchical structure (e.g., of up to ten or more levels of depth), optionally stored internally as a JSON-encoded tree. A given node in the JSON structure may include fields such as question_id (question identifier), question_text (the text for the questions), answer_options[ ] (e.g., two or more answer choices), max_score, applicable_controls[ ], reference_urls[ ], and children[ ], enabling the system to persist fully dynamic branching logic.

A given question may include multiple selectable answer options (e.g., field answer_options[ ]), wherein a given option may optionally itself define its own sub-question subtree. When a user selects a particular answer option, the system may dynamically expand the corresponding subtree to present additional dependent questions, thereby enabling highly granular and conditionally branching compliance assessments. This branching logic enables different question paths to be triggered based on answers, regulatory frameworks, and/or organization-specific configurations. To support compliance mapping, individual questions may optionally be associated with one or more regulatory references, including applicable controls (e.g., NIST 800-53, CIS Controls, ISO 27001 clauses), specific regulatory citations, or links to authoritative reference documentation hosted internally or externally. These associations may be stored as structured metadata to enable later auditing, scoring, cross-referencing, and automated remediation.

The administrative portal optionally is configured to enable customizable and highly granular scoring logic. A given question may define a max_score (maximum score) parameter or similar scoring attribute, and the system may automatically compute composite scores for parent questions based on the aggregated max_score values of the nested sub-questions. Score aggregation may optionally be performed via recursive traversal of the question tree, enabling weighted, proportional, tiered, and/or rule-based scoring algorithms. The system may optionally be configured to enable administrators to specify category weights, conditional scoring rules, threshold-based scoring, and/or dynamic scoring modifiers triggered by specific answer selections.

To enhance data integrity, the system may instantiate a draft-versus-published workflow for surveys. While in draft mode, surveys may be edited freely, and the system may maintain versioned snapshots to preserve edit history. Once a survey reaches a finalized state, an administrator may invoke a publish action (e.g., by activating a publish control) that converts the survey into a locked, immutable version. After publishing, the survey may optionally be cryptographically version-tagged or assigned a unique version identifier to ensure that downstream client responses are consistently tied to a specific version via a survey version identifier stored in association with the responses. The system optionally comprises deployment mechanisms (e.g., initiated by activating a deployment control) that propagates published surveys to one or more client organizations and systems. Deployment may comprise replicating or provisioning the survey structure to separate tenant environments or accounts, ensuring isolation of client data and independent lifecycle management.

Multi-tenant permissions may optionally be enforced through a role-based access control (RBAC) framework. The system may be configured to enable a hierarchy of administrative roles (e.g., super-administrator, enterprise administrator, company owner, standard administrator, end-user, etc.), wherein a given role is associated with respective permissions governing survey creation, editing, publishing, deployment, and/or data access. Optionally, RBAC enforcement may be implemented through policy evaluation middleware that inspects user roles and tenant membership before authorizing any action. This architecture enhances data security and advantageously ensures secure separation of data between different client organizations, prevents unauthorized access to administrative functions, and restricts survey authoring and publishing capabilities to suitably privileged users. Optionally, the multi-tenant security model may incorporate logical data partitioning, per-tenant encryption keys, and/or audit logging to further ensure data isolation and compliance with regulatory requirements.

Optionally, the system maintains a comprehensive audit logging infrastructure that records relevant user actions, survey activity, and AI-generated events. A system-level audit log captures authentication activity (e.g., login and/or logout events), timestamps marking the beginning and end of user sessions, survey creation, editing, saving of different versions, completion events, and/or associated metadata such as user identifiers, email addresses, names, roles, company identifiers, enterprise identifiers, and/or device-level information such as IP address and user-agent strings. Additional structured metadata may be stored in JSON form to support downstream analytics and security reviews.

Optionally, a separate AI-specific audit log may be instantiated that records the details of AI-generated recommendations, such as the specific model used (e.g., primary or secondary), the type of prompt issued (e.g., retrieval, validation, or suggestion), the input prompt text, the AI-generated output, and/or parsed structured results such as answers, scores, and/or compliance designations. Optionally, the system records the contextual document segments retrieved during RAG execution, the confidence values assigned to a given recommendation, token consumption metrics, latency (e.g., the time it takes for the system to generate a recommendation or perform other action), error states, and/or success markers. A given entry in a given audit log is optionally associated with the corresponding tenant, survey, question, response, user, and/or company, providing traceability across versions and changes. Optionally, when user responses are determined by the system to be non-compliant, the system automatically creates remediation steps containing the identified weakness, the applicable compliance control, recommended corrective actions, assigned priority, and/or categorical classification. These remediation actions may be transmitted to external systems through webhook integrations comprising event-driven, real-time HTTP callbacks that automatically push data between applications, (e.g., workflow automation systems) when a specific event occurs to support automatic task creation and governance workflows.

Optionally, the system provides an AI operational dashboard configured to monitor AI performance and administrative settings. The dashboard may be configured to display on a user monitor device system-wide metrics such as the total volume of AI suggestions generated, the number and type of validation issues detected, user adoption rates of AI recommendations, and/or other activity analyses. The dashboard optionally comprises a detailed validation table that enables administrators to review issues at the level of individual questions, including the associated AI model, validation results, timestamps, and/or relevant user or company context. Optionally, the dashboard may comprise statistical views illustrating usage patterns across organizations, such as acceptance, rejection, and/or override of AI suggestions by end-users.

The dashboard optionally comprises a rules-management interface enabling administrators to configure the system and user prompts for the primary and secondary AI models, upload and maintain ruleset documents, and/or manage the corpus of compliance reference materials. The dashboard may comprise integrated links to the AI audit logs that enable explainable and auditable AI operation, facilitating compliance reviews and ensuring transparency in automated decision support. A user-feedback module is optionally provided that captures and tracks user interactions with AI recommendations (e.g., approvals, rejections, manual modifications, and/or the like) to enable continuous improvement of AI guidance quality.

Thus, computer-based methods and systems are described herein configured to identify gaps between policies/procedures and standards, to generate compliance scores, and to generate remediation suggestions. Optionally, POA&Ms may be automatically generated. Optionally, RAG-enhanced generative models may be used to perform certain functions described herein. Systems and processes are described that provide for the automated management of compliance assessments, the maintenance of standards compliance, and the generation of notifications regarding the foregoing.

An aspect of the present disclosure relates to a computer system configured to enhance cybersecurity of an information system, the computer system comprising: a network interface; at least one processing device configured to: receive a first document comprising cybersecurity policies related to at least the information system; receive a second document comprising cybersecurity procedures related to at least the information system; receive a third document comprising a cybersecurity standard comprising at least a first plurality of cybersecurity categories; identify, for the first plurality of cybersecurity categories, gaps between: the cybersecurity policies and/or procedures and the cybersecurity standard; determine based at least on one of the identified gaps, if cybersecurity remediation techniques are to be recommended; and at least partly in response to determining that cybersecurity remediation techniques are to be recommended, output cybersecurity remediation techniques and cause, at least in part, the cybersecurity remediation techniques to be implemented.

Optionally, the computer system is configured to utilize a generative model augmented with Retrieval-Augmented Generation to identify, for the first plurality of cybersecurity categories, gaps between: the cybersecurity policies and/or procedures and the cybersecurity standard. Optionally, the computer system is configured to utilize a generative model augmented with Retrieval-Augmented Generation to generate a set of cybersecurity remediation techniques to remediate identified gaps. Optionally, the cybersecurity remediation techniques comprise use of: complex passwords, multi-factor authentication, software updates, hardware updates, data backup, data encryption, a network firewall, a VPN, anti-virus and anti-malware software, endpoint protection, intrusion detection/prevention system, and/or a cyberattack recovery procedure. Optionally, identifying, for the first plurality of cybersecurity categories, gaps between: the cybersecurity policies and/or procedures and the cybersecurity standard; and further comprises generating compliance scores for respective categories corresponding to the cybersecurity categories gaps. Optionally, identifying, for the first plurality of cybersecurity categories, gaps between: the cybersecurity policies and/or procedures and the cybersecurity standard; and further comprises generating an overall weight-based average compliance score. Optionally, the computer system is further configured to: generate a cybersecurity assessment questionnaire; receive responses to the cybersecurity assessment questionnaire; use the responses to the cybersecurity assessment questionnaire to identify, for the first plurality of cybersecurity categories, gaps between: the cybersecurity policies and/or procedures and the cybersecurity standard. Optionally, the computer system is configured to automatically detect a change in the third document comprising a cybersecurity standard, and at least partly in response to detecting the change in the third document comprising the cybersecurity standard, identify, for the first plurality of cybersecurity categories, gaps between: the cybersecurity policies and/or procedures and the cybersecurity standard included in the changed third document; determine, based at least on one of the identified gaps between the cybersecurity policies and/or procedures and the cybersecurity standard included in the changed third document, if updated cybersecurity remediation techniques are to be recommended; and at least partly in response to determining that updated cybersecurity remediation techniques are to be recommended, output updated cybersecurity remediation techniques and cause, at least in part, the updated cybersecurity remediation techniques to be implemented. Optionally, the computer system is configured to automatically generate a plan of action comprising the cybersecurity remediation techniques, milestones and associated timing, and resources needed. Optionally, the at least one processing device comprises a processing device including an array of cores, local high speed memory, high speed buses, an instruction set optimized for performing tensor operations, and vertically stacked integrated circuits.

An aspect of the present disclosure relates to a computer-implemented method, the method comprising: receiving over a network, at a computer system comprising a processing device comprising a plurality of cores within a first package, a first document comprising a first set of policies; receiving over the network, at the computer system, a second document comprising a first set of procedures; receiving over the network, at the computer system, a third document comprising a standard comprising at least a first plurality of categories; identifying using a generative model augmented with Retrieval-Augmented Generation executed using one or more processing devices, for the first plurality of categories, gaps between: the first set of policies and/or first set of procedures, and the standard; determining based on at least one of the identified gaps, if remediation techniques are to be recommended; and at least partly in response to determining remediation techniques are to be recommended, outputting remediation techniques and enabling the remediation techniques to be implemented.

Optionally, the first set of policies comprises cybersecurity policies, and the first set of procedures comprises cybersecurity procedures. Optionally, the remediation techniques comprise use of: complex passwords, multi-factor authentication, software updates, hardware updates, data backup, data encryption, a network firewall, a VPN, anti-virus and anti-malware software, endpoint protection, intrusion detection/prevention system, and/or a cyberattack recovery procedure. Optionally, identifying, for the first plurality of categories gaps between: the first set of policies and/or procedures, and the standard; further comprises generating compliance scores for respective categories corresponding to the categories gaps. Optionally, identifying, for the first plurality of categories gaps between: the first set of policies and/or procedures, and the standard; further comprises generating an overall weight-based average compliance score. Optionally, generating an assessment questionnaire; receiving responses to the assessment questionnaire; using the responses to the assessment questionnaire to identify, for the first plurality of categories gaps between: the first set of policies and/or procedures, and the standard.

An aspect of the present disclosure relates to a non-transitory computer readable data media that stores computer executable instructions that when executed by a computing device, cause the computing device to perform operations comprising: receiving a first document comprising a first set of policies; receiving a second document comprising a first set of procedures; receiving a third document comprising a standard comprising at least a first plurality of categories; identifying, using a generative model, for the first plurality of categories gaps between: the first set of policies and/or first set of procedures, and the standard; determining based on at least one of the identified gaps, if remediation techniques are to be recommended; and at least partly in response to determining remediation techniques are to be recommended, outputting remediation techniques and enabling the remediation techniques to be implemented.

Optionally, identifying using a generative model executed using one or more processing devices, for the first plurality of categories gaps between: the first set of policies and/or first set of procedures and the standard; further comprises using a Retrieval-Augmented Generation to augment performance of the generative model. Optionally, the first set of policies comprises cybersecurity policies, and the first set of procedures comprises cybersecurity procedures. Optionally, the remediation techniques comprise use of: complex passwords, multi-factor authentication, software updates, hardware updates, data backup, data encryption, a network firewall, a VPN, anti-virus and anti-malware software, endpoint protection, intrusion detection/prevention system, and/or a cyberattack recovery procedure. Optionally, identifying, for the first plurality of categories gaps between: the first set of policies and/or procedures, and the standard; further comprises generating compliance scores for respective categories corresponding to the respective category gaps. Optionally, identifying, for the first plurality of categories gaps between: the first set of policies and/or procedures, and the standard; and further comprises generating an overall weight-based average compliance score. Optionally, the operations further comprises: generating an assessment questionnaire; receiving responses to the assessment questionnaire; using the responses to the assessment questionnaire to identify, for the first plurality of categories gaps between: the first set of policies and/or procedures, and the standard.

An aspect of the present disclosure relates to systems and methods configured to receive a first document comprising cybersecurity policies, a second document comprising cybersecurity procedures, and a third document comprising a cybersecurity standard comprising cybersecurity categories. Gaps may be identified between the cybersecurity policies and/or procedures and the cybersecurity standard. Based on the identified gaps, a determination is made as to whether recommendations for cybersecurity remediation techniques are to be generated. In response to determining that cybersecurity remediation techniques are to be recommended, cybersecurity remediation technique recommendations are generated and the cybersecurity remediation techniques may be implemented. Optionally, a generative model augmented with RAG is utilized to identify the gaps and/or to generate recommendations. Optionally, to enhance performance, the system comprises a processing device including an array of cores, local high speed memory, high speed buses, an instruction set optimized for performing tensor operations, and/or vertically stacked integrated circuits. Optionally, the processing device comprises a plurality of chiplets (dies) in a single package.

An aspect of the present disclosure relates to computer system configured to enhance cybersecurity of an information system, the computer system comprising: a network interface; at least one processing device configured to: retrieve, using the network interface, contextual materials via a retrieval augmented generation (RAG) component; generate, by a primary model, a compliance recommendation with respect to a first source and associated rationale based at least in part on a prompt and the retrieved contextual materials; validate, by a secondary model distinct from the primary model, the compliance recommendation in a multistage validation process comprising: generating independent embeddings for the recommendation, the associated rationale, and portions of the retrieved contextual materials; computing similarity scores, cross-attention weights, and/or token level alignment metrics to determine support for the recommendation and/or associated rationale in in the retrieved materials; evaluating conformance to a predefined ruleset of criteria and/or interpretive directives; detecting hallucinations by identifying assertions lacking source support above a similarity threshold; detecting omissions via salience-weighted coverage analysis and/or requirement to response mapping; detecting logical inconsistencies via entailment/contradiction classification; producing a structured validation result comprising a confidence score, identified issue categories, corrective guidance, and/or citations to supporting materials; and using the validation result to enable enhancement of at least one compliance recommendation.

Optionally, the system is configured to generate the compliance recommendation in real time at least partly in response to a user answer to a compliance survey question. Optionally, detecting hallucinations comprises identifying factual assertions for which no retrieved context data achieves a similarity score greater than a configurable threshold and classifying a corresponding assertion as unsupported. Optionally, detecting logical inconsistencies comprises applying a transformer based entailment/contradiction classifier to the recommendation and/or the rationale, to identify self-contradictions and/or misinterpretations of a first standard. Optionally, the RAG component converts retrieved documents into embeddings stored in a vector database and provides selected context segments to the primary and secondary models for grounding and verification. Optionally, the system is configured to provide an administrative portal configured to enable authoring, versioning, publishing, and deployment of compliance surveys using hierarchical recursive question structures, and to enforce multi-tenant role based access control (RBAC) to isolate tenant data and restrict survey authoring, publishing, and deployment privileges. Optionally, =the system is configured to maintain an audit log configured to record authentication events, survey changes, user role metadata, AI model identifiers, prompts, generated outputs, and validation results. Optionally, the system is configured to instantiate an AI operational dashboard configured to display metrics on AI suggestions and validation issues, recommendation adoption and override rates, and to provide a rules management interface that enables prompt configuration and ruleset maintenance, with integrated links to audit log entries for explainability and administrative review. Optionally, at least one processing device comprises a plurality of chiplets (dies) in a single package.

Systems and modules described herein may comprise software, firmware, hardware, or any combination(s) of software, firmware, or hardware suitable for the purposes described. Software and other modules may reside and execute on servers, workstations, personal computers, computerized tablets, PDAs, and other computing devices suitable for the purposes described herein. Software and other modules may be accessible via local computer memory, via a network, via a browser, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, interactive voice response, command line interfaces, and other suitable interfaces.

Further, processing of the various components of the illustrated systems can be distributed across multiple machines, networks, and other computing resources, or may comprise a standalone system. Two or more components of a system can be combined into fewer components. Various components of the illustrated systems can be implemented in one or more virtual machines, rather than in dedicated computer hardware systems and/or computing devices. Likewise, the data repositories shown can represent physical and/or logical data storage, including, e.g., storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Embodiments are also described above with reference to flow chart illustrations and/or block diagrams of methods, apparatus (systems) and computer program products. Each block of the flow chart illustrations and/or block diagrams, and combinations of blocks in the flow chart illustrations and/or block diagrams, may be implemented by computer program instructions. Such instructions may be provided to a processor of a general purpose computer, special purpose computer, specially-equipped computer (e.g., comprising a high-performance database server, a graphics subsystem, etc.) or other programmable data processing apparatus to produce a machine, such that the instructions, which execute via the processor(s) of the computer or other programmable data processing apparatus, create means for implementing the acts specified in the flow chart and/or block diagram block or blocks. These computer program instructions may also be stored in a non-transitory computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded to a computing device or other programmable data processing apparatus to cause operations to be performed on the computing device or other programmable apparatus to produce a computer implemented process such that the instructions which execute on the computing device or other programmable apparatus provide steps for implementing the acts specified in the flow chart and/or block diagram block or blocks.

While the phrase “click” may be used with respect to a user selecting a control, menu selection, or the like, other user inputs may be used, such as voice commands, text entry, gestures, etc. User inputs may, by way of example, be provided via an interface, such as via text fields, wherein a user enters text, and/or via a menu selection (e.g., a drop down menu, a list or other arrangement via which the user can check via a check box or otherwise make a selection or selections, a group of individually selectable icons, etc.). When the user provides an input or activates a control, a corresponding computing system may perform the corresponding operation. Some or all of the data, inputs and instructions provided by a user may optionally be stored in a system data store (e.g., a database), from which the system may access and retrieve such data, inputs, and instructions. The notifications and user interfaces described herein may be provided via a Web page, a dedicated or non-dedicated phone or mobile application, computer application, a short messaging service message (e.g., SMS, MMS, etc.), instant messaging, email, push notification, audibly, via haptic feedback, and/or otherwise.

The user terminals described herein may be in the form of a mobile communication device (e.g., a cell phone), laptop, tablet computer, interactive television, game console, media streaming device, head-wearable display, networked watch, etc. The user terminals may optionally include displays, user input devices (e.g., touchscreen, keyboard, mouse, microphone, camera, touch pad, etc.), network interfaces, etc.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention. These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates other aspects of the invention in any number of claim forms. Any claims intended to be treated under 35 U.S.C. § 112(f) will begin with the words “means for,” but use of the term “for” in any other context is not intended to invoke trea104tment under 35 U.S.C. § 112(f). Accordingly, the applicant reserves the right to pursue additional claims after filing this application, in either this application or in a continuing application.

What is claimed is:

1. A computer system configured to enhance cybersecurity of an information system, the computer system comprising:
a network interface;
at least one processing device configured to:
receive a first document comprising cybersecurity policies related to at least the information system;
receive a second document comprising cybersecurity procedures related to at least the information system;
receive a third document comprising a cybersecurity standard comprising at least a first plurality of cybersecurity categories;
identify, for the first plurality of cybersecurity categories, gaps between:
the cybersecurity policies and/or procedures and
the cybersecurity standard;
determine based at least on one of the identified gaps, if cybersecurity remediation techniques are to be recommended; and
at least partly in response to determining that cybersecurity remediation techniques are to be recommended, output cybersecurity remediation techniques and cause, at least in part, the cybersecurity remediation techniques to be implemented.

2. The computer system as defined in claim 1, wherein the computer system is configured to utilize a generative model augmented with Retrieval-Augmented Generation to identify, for the first plurality of cybersecurity categories, gaps between:
the cybersecurity policies and/or procedures, and
the cybersecurity standard.

3. The computer system as defined in claim 1, wherein the computer system is configured to utilize a generative model augmented with Retrieval-Augmented Generation to generate a set of cybersecurity remediation techniques to remediate identified gaps.

4. The computer system as defined in claim 1, wherein the cybersecurity remediation techniques comprise use of: complex passwords, multi-factor authentication, software updates, hardware updates, data backup, data encryption, a network firewall, a VPN, anti-virus and anti-malware software, endpoint protection, intrusion detection/prevention system, and/or a cyberattack recovery procedure.

5. The computer system as defined in claim 1, wherein identifying, for the first plurality of cybersecurity categories, gaps between:
the cybersecurity policies and/or procedures, and
the cybersecurity standard; and
further comprises generating compliance scores for respective categories corresponding to the cybersecurity categories gaps and/or an overall weight-based average compliance score.

6. The computer system as defined in claim 1, wherein the computer system is further configured to:
generate a cybersecurity assessment questionnaire;
receive responses to the cybersecurity assessment questionnaire; and
use the responses to the cybersecurity assessment questionnaire to identify, for the first plurality of cybersecurity categories, gaps between:
the cybersecurity policies and/or procedures, and
the cybersecurity standard.

7. The computer system as defined in claim 1, wherein the computer system is configured to automatically detect a change in the third document comprising a cybersecurity standard, and at least partly in response to detecting the change in the third document comprising the cybersecurity standard,
identify, for the first plurality of cybersecurity categories, gaps between:
the cybersecurity policies and/or procedures and
the cybersecurity standard included in the changed third document;
determine, based at least on one of the identified gaps between the cybersecurity policies and/or procedures and the cybersecurity standard included in the changed third document, if updated cybersecurity remediation techniques are to be recommended; and
at least partly in response to determining that updated cybersecurity remediation techniques are to be recommended, output updated cybersecurity remediation techniques and cause, at least in part, the updated cybersecurity remediation techniques to be implemented.

8. A computer-implemented method, the method comprising:
receiving over a network, at a computer system comprising a processing device comprising a plurality of cores within a first package, a first document comprising a first set of policies;
receiving over the network, at the computer system, a second document comprising a first set of procedures;
receiving over the network, at the computer system, a third document comprising a standard comprising at least a first plurality of categories;
identifying using a generative model augmented with Retrieval-Augmented Generation executed using one or more processing devices, for the first plurality of categories, gaps between:
the first set of policies and/or first set of procedures and
the standard;
determining based on at least one of the identified gaps, if remediation techniques are to be recommended; and
at least partly in response to determining remediation techniques are to be recommended, outputting remediation techniques and enabling the remediation techniques to be implemented.

9. The computer-implemented method as defined in claim 8, wherein the first set of policies comprises cybersecurity policies, and the first set of procedures comprises cybersecurity procedures and the remediation techniques comprise use of: complex passwords, multi-factor authentication, software updates, hardware updates, data backup, data encryption, a network firewall, a VPN, anti-virus and anti-malware software, endpoint protection, intrusion detection/prevention system, and/or a cyberattack recovery procedure.

10. The computer-implemented method as defined in claim 8, wherein identifying, for the first plurality of categories gaps between:
the first set of policies and/or procedures and
the standard;
further comprises generating compliance scores for respective categories corresponding to the corresponding category gaps and/or generating an overall weight-based average compliance score.

11. The computer-implemented method as defined in claim 8, the method further comprising:
generating an assessment questionnaire;
receiving responses to the assessment questionnaire; and
using the responses to the assessment questionnaire to identify, for the first plurality of categories gaps between:
the first set of policies and/or procedures, and
the standard.

12. The computer-implemented method as defined in claim 8, the method further comprising:
automatically detecting a change in the standard comprising at least the first plurality of categories, and at least partly in response to detecting the change in the standard, identify, for the first plurality of categories gaps between:
the policies and/or procedures, and
the changed standard;
determine, based at least on one of the identified gaps between the policies and/or procedures and the changed standard, if updated remediation techniques are to be recommended; and
at least partly in response to determining that updated remediation techniques are to be recommended, output updated remediation techniques and cause, at least in part, the updated remediation techniques to be implemented.

13. The computer-implemented method as defined in claim 8, the method further comprising automatically generating a plan of action comprising the remediation techniques, milestones and associated timing, and resources needed.

14. A computer system configured to enhance cybersecurity of an information system, the computer system comprising:
a network interface;
at least one processing device configured to:
retrieve, using the network interface, contextual materials via a retrieval augmented generation (RAG) component;
generate, by a primary model, a compliance recommendation with respect to a first source and associated rationale based at least in part on a prompt and the retrieved contextual materials;
validate, by a secondary model distinct from the primary model, the compliance recommendation in a multistage validation process comprising:
generating independent embeddings for the recommendation, the associated rationale, and portions of the retrieved contextual materials;
computing similarity scores, cross-attention weights, and/or token level alignment metrics to determine support for the recommendation and/or associated rationale in in the retrieved materials;
evaluating conformance to a predefined ruleset of criteria and/or interpretive directives;
detecting hallucinations by identifying assertions lacking source support above a similarity threshold;
detecting omissions via salience-weighted coverage analysis and/or requirement to response mapping;
detecting logical inconsistencies via entailment/contradiction classification;
producing a structured validation result comprising a confidence score, identified issue categories, corrective guidance, and/or citations to supporting materials; and
using the validation result to enable enhancement of at least one compliance recommendation.

15. The computer system of claim 14, wherein the system is configured to generate the compliance recommendation in real time at least partly in response to a user answer to a compliance survey question.

16. The computer system of claim 14, wherein detecting hallucinations comprises identifying factual assertions for which no retrieved context data achieves a similarity score greater than a configurable threshold and classifying a corresponding assertion as unsupported.

17. The computer system of claim 14, wherein detecting logical inconsistencies comprises applying a transformer based entailment/contradiction classifier to the recommendation and/or the rationale, to identify self-contradictions and/or misinterpretations of a first standard.

18. The computer system of claim 14, wherein the RAG component converts retrieved documents into embeddings stored in a vector database and provides selected context segments to the primary and secondary models for grounding and verification.

19. The computer system of claim 14, wherein the system is configured to provide:
an administrative portal configured to enable authoring, versioning, publishing, and deployment of compliance surveys using hierarchical recursive question structures, and to enforce multi-tenant role based access control (RBAC) to isolate tenant data and restrict survey authoring, publishing, and deployment privileges; and
instantiate an AI operational dashboard configured to display metrics on AI suggestions and validation issues, recommendation adoption and override rates, and to provide a rules management interface that enables prompt configuration and ruleset maintenance, with integrated links to audit log entries for explainability and administrative review.

20. The computer system of claim 14, wherein the system is configured to maintain an audit log configured to record authentication events, survey changes, user role metadata, AI model identifiers, prompts, generated outputs, and validation results.
